(19) United States
(12) Patent Application Publication
(10) Pub. No.: US 2010/0211511 A1
(43) Pub. Date: Aug. 19, 2010

(54) ARTICLE RESIDUAL VALUE PREDICTING DEVICE

(76) Inventor: Muneo Kawasaki, Tokyo (JP)

Correspondence Address: WENDEROTH, LIND & PONACK, L.L.P., 1030 15th Street, N.W.,, Suite 400 East, Washington, DC, 20005-1503, US

(21) Appl. No.: 12/675,026

(22) PCT Filed: Aug. 28, 2008
(86) PCT No.: PCT/JP2008/065383

§ 371 Date: Mar. 12, 2010

(30) Foreign Application Priority Data
Aug. 30, 2007 (JP) 2007-223490
Apr. 24, 2008 (JP) 2008-113368

(51) Int. Cl. G06Q 10/00; G06Q 50/00

(52) U.S. Cl. 705/306; 705/348

(57) ABSTRACT

An article residual value predicting device of the invention comprises an article residual value predicting computer, a first data memory device connected to the article residual value predicting computer to store, as basal record data, respective items such as article names, used article values for each article type, new article values for each article type, and year and month data to which the used article value is applied, a second data memory device connected to the article residual value predicting computer to store item category scores. The article residual value predicting computer comprises article residual rate proven-value calculating means for reading out the used article value and new article value for each article type stored in the first data memory device, calculating article residual rate proven-value from the ratio of the used article value to the new article value, and storing a calculated result thus obtained as an article residual rate proven-value in the first data memory device, category score calculating means for reading out the article name, article residual rate proven-value, year data to which the used article value is applied and month data to which the used article value is applied, which are stored in the first data memory device, and calculating an item category score by performing a regression analysis based on the qualification theory I using the readout article residual rate proven-value as an objective variable and the readout article name, the year to which the used article value is applied as an explanatory variable and the month to which the used article value is applied as an explanatory variable, and storing a calculated score thus obtained in the second data memory device, article residual rate predictive-value calculating means for reading out the score stored in the second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(month-classified score)+(constant value)”, and article residual rate calculating means for multiplying the article residual rate predictive-value by a new article value to calculate an article residual value. The first data memory device serves to store maker-classified new article sales quantity or article name-classified new article sales quantity before elapsed years. The article residual value predicting computer further comprises a first weight coefficient calculating means for reading out the maker-classified new article sales quantity or article name-classified new article sales quantity before elapsed years stored in the first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in the first data memory device, and weighting means for reading out the weight coefficient based on the calculated new article sales quantity from the first data memory device and duplicating the number of relevant records stored in the first data memory device corresponding to the weight coefficient based on the readout new article sales quantity and storing the record numbers increased by duplicating. The category score calculating means serves to perform the aforementioned regression analysis using concurrently all the relevant records weighted by the weighting means collectively.

### TECHNICAL FIELD

This invention relates to an article residual value predicting device for predicting the residual value of an article or an automobile. Particularly, this invention relates to an article residual value predicting device, an article residual value predicting system, a car residual value predicting device and a car residual value predicting system effective for categorization data incapable of quantifying the factors affecting the residual value of an article or the residual value of a car.

### BACKGROUND ART

As one of the techniques for predicting the future residual value of the article or car whose value is gradually decreased with time, there can be cited a depreciation method which is an accounting technique. However, the result obtained by the depreciation method often loses touch with the actual residual value of the article or car in the marketplace since the article residual value or car residual value determined by the number of elapsed years are uniformly incorporated in a fixed rate method and fixed amount method of the depreciation method irrespective of attribute information of the article or car.

From the viewpoint of the car as one example of the articles, the predictive residual value of a car, which is required by a car-leasing dealer, is an actual residual value of the car dealt with as a used car in the marketplace. It may be sometimes adopted a scheme in which the car residual value after the elapse of the lease period is predicted at lease inception to determine the lease fee of the car on the basis of the predictive car residual value. Accordingly, a technique capable of reasonably predicting the car residual value with accuracy is called for.

The car residual value prediction technique developed conventionally serves to make a prediction following a theoretical equation such as a multiple regression analysis premised on numerical type data only. However, as the factors greatly affecting the residual value prediction are categorization data, basal record data subdivided with respect to each attribute value of the factors are applied to the theoretical equation such as the multiple regression analysis. Thus, the conventional car residual value prediction technique has a law of great numbers disabled adequately to consequently cause a disadvantage of being easily affected by aberrant values.

In order to make up for the shortcoming described above, there has been another car residual value prediction technique designed to correct the actual attribute value in a standard car residual value prediction upon making the standard car residual value prediction by the theoretical equation.

As one example of the conventional car residual value prediction techniques, there has been proposed a technique in that a future price (residual value) of a property is predicted by reference to a current market price valued at a used article market of the property of the same sort sold in past times, so that a future exchange value evaluated when the property such as a used car is disposed in the future can be comprehended to predict the residual value with a higher accuracy than a conventional depreciation method. (Patent Literature 1)

Patent Literature 1: Japanese Patent No. 3581094

### DISCLOSURE OF INVENTION

### Problems to be Solved by the Invention

The car residual value prediction technique disclosed in Patent Literature 1 suffers from a disadvantage in that no optimization with statistical analysis is performed to deteriorate prediction accuracy because of unstandardized correction artificially made for selection of typical attribute value and restoration of actual attribute value.

Furthermore, the conventionally developed car residual value prediction technique has its fundamental limits on improvement in prediction accuracy of the car residual value since categorization data as the factors affecting the car residual value cannot concurrently be dealt with collectively.

Thus, in the light of the fact that the predictive article residual value or the predictive car residual value required for a dealer in leasing articles or cars represents the exchangeable value in the market of used articles or used cars, the present invention seeks to provide an article residual value predicting device, an article residual value predicting system, a car residual value predicting device and a car residual value predicting system, capable of predicting the residual value of an article or a car with a high degree of accuracy, which can be assumed as future exchangeable value in the market of used articles or used cars.

### Means for Solving the Problems

The article residual value predicting device according to the present invention comprises an article residual value predicting computer, a first data memory device connected to the article residual value predicting computer to store, as basal record data, respective items such as article names, used article values for each article type, new article values for each article type, and year and month data to which the used article value is applied, a second data memory device connected to the article residual value predicting computer to store item category scores (score for each of item categories). The article residual value predicting computer comprises article residual rate proven-value calculating means for reading out the used article value and new article value for each article type stored in the first data memory device, calculating article residual rate proven-value from the ratio of the used article value to the new article value, and storing a calculated result thus obtained as an article residual rate proven-value in the first data memory device, category score calculating means for reading out the article name, article residual rate proven-value, and year and month data to which the used article value is applied, which are stored in the first data memory device, and calculating an item category score by performing a regression analysis based on the qualification theory I using the readout article residual rate proven-value as an objective variable and the readout article name, the year to which the used article value is applied as an explanatory variable and the month to which the used article value is applied as an explanatory variable, and storing a calculated score thus obtained in the second data memory device, article residual rate predictive-value calculating means for reading out the score stored in the second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(month-classified score)+(constant value)”, and article residual rate calculating means for multiplying the article residual rate predictive-value by a new article value to calculate an article residual value. The first data memory device serves to store maker-classified new article sales quantity or article name-classified new article sales quantity before elapsed years. The article residual value predicting computer further comprises a first weight coefficient calculating means for reading out the maker-classified new article sales quantity or article name-classified new article sales quantity before elapsed years stored in the first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in the first data memory device, and weighting means for reading out the weight coefficient based on the calculated new article sales quantity from the first data memory device and duplicating the number of relevant records stored in the first data memory device corresponding to the weight coefficient based on the readout new article sales quantity and storing the record numbers increased by duplicating. The category score calculating means serves to perform the aforementioned regression analysis using concurrently all the relevant records weighted by the weighting means collectively.

The article residual value predicting device comprises an article residual value predicting computer, a first data memory device connected to the article residual value predicting computer to store, as basal record data, respective items such as article names, used article values for each article type, new article values for each article type, and year and month data to which the used article value is applied, a second data memory device connected to the article residual value predicting computer to store item category scores. The article residual value predicting computer comprises article residual rate proven-value calculating means for reading out the used article value and new article value for each article type stored in the first data memory device, calculating article residual rate proven-value from the ratio of the used article value to the new article value, and storing a calculated result thus obtained as an article residual rate proven-value in the first data memory device, category score calculating means for reading out the article name, article residual rate proven-value, and year and month data to which the used article value is applied, which are stored in the first data memory device, and calculating an item category score by performing a regression analysis based on the qualification theory I using the readout article residual rate proven-value as an objective variable and the readout article name, the year to which the used article value is applied as an explanatory variable and the month to which the used article value is applied as an explanatory variable, and storing a calculated score thus obtained in the second data memory device, article residual rate predictive-value calculating means for reading out the score stored in the second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(month-classified score)+(constant value)”, and article residual rate calculating means for multiplying the article residual rate predictive-value by a new article value to calculate an article residual value. The first data memory device serves to store maker-classified new article sales quantity or article name-classified new article sales quantity before elapsed years, and respectively store one or more distribution colors differing from one another and used article distribution color values involved in the distribution colors. Further, the article residual value predicting computer comprises a first weight coefficient calculating means for reading out the maker-classified new article sales quantity or article name-classified new article sales quantity before elapsed years stored in the first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in the first data memory device, second weight coefficient calculating means for calculating the distribution color-classified weight coefficient for each distribution color according to the different distribution colors stored in the first data memory device and storing the calculated distribution color-classified weight coefficient in the first data memory device, weighting means for reading out the weight coefficient based on the calculated new article sales quantity from the first data memory device and the distribution color-classified weight coefficient, multiplying the weight coefficient based on the calculated new article sales quantity by the first data memory device and the distribution color-classified weight coefficient to calculate a total weight coefficient and duplicating the number of relevant records stored in the first data memory device corresponding to the calculated total weight coefficient and storing the record numbers increased by duplicating. The category score calculating means serves to perform the aforementioned regression analysis using concurrently all the relevant records weighted by the weighting means collectively.

Further, the article residual value predicting device according to the invention comprises an article residual value predicting computer, a first data memory device connected to the article residual value predicting computer to store, as basal record data, respective items such as article names, used article values for each article type, new article values for each article type, and year data to which the used article value is applied, a second data memory device connected to the article residual value predicting computer to store item category scores. The article residual value predicting computer comprises article residual rate proven-value calculating means for reading out the used article value and new article value for each article type stored in the first data memory device, calculating article residual rate proven-value from the ratio of the used article value to the new article value, and storing a calculated result thus obtained as an article residual rate proven-value in the first data memory device, category score calculating means for reading out the article name, article residual rate proven-value and year data to which the used article value is applied, which are stored in the first data memory device, and calculating an item category score by performing a regression analysis based on the qualification theory I using the readout article residual rate proven-value as an objective variable and the readout article name, and the year to which the used article value is applied as an explanatory variable, and storing a calculated score thus obtained in the second data memory device, article residual rate predictive-value calculating means for reading out the score stored in the second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(constant value)”, and article residual rate calculating means for multiplying the article residual rate predictive-value by a new article value to calculate an article residual value. The first data memory device serves to store maker-classified new article sales quantity or article name-classified new article sales quantity before elapsed years. Further, the article residual value predicting computer comprises a first weight coefficient calculating means for reading out the maker-classified new article sales quantity or article name-classified new article sales quantity before elapsed years stored in the first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in the first data memory device, weighting means for reading out the weight coefficient based on the calculated new article sales quantity from the first data memory device, duplicating the number of relevant records stored in the first data memory device corresponding to the weight coefficient based on the readout new article sales quantity and storing the record numbers increased by duplicating. The category score calculating means serves to perform the aforementioned regression analysis using concurrently all the relevant records weighted by the weighting means collectively.

Furthermore, the article residual value predicting device according to the invention comprises an article residual value predicting computer, a first data memory device connected to the article residual value predicting computer to store, as basal record data, respective items such as article names, used article values for each article type, new article values for each article type, and year data to which the used article value is applied, a second data memory device connected to the article residual value predicting computer to store item category scores. The article residual value predicting computer comprises article residual rate proven-value calculating means for reading out the used article value and new article value for each article type stored in the first data memory device, calculating article residual rate proven-value from the ratio of the used article value to the new article value, and storing a calculated result thus obtained as an article residual rate proven-value in the first data memory device, category score calculating means for reading out the article name, article residual rate proven-value and year data to which the used article value is applied, which are stored in the first data memory device, and calculating an item category score by performing a regression analysis based on the qualification theory I using the readout article residual rate proven-value as an objective variable and the readout article name, the year to which the used article value is applied as an explanatory variable, and storing a calculated score thus obtained in the second data memory device, article residual rate predictive-value calculating means for reading out the score stored in the second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(constant value)”, and article residual rate calculating means for multiplying the article residual rate predictive-value by a new article value to calculate an article residual value. The first data memory device serves to store maker-classified new article sales quantity or article name-classified new article sales quantity before elapsed years, and respectively store one or more distribution colors differing from one another and used article distribution color values involved in the distribution colors. Further, the article residual value predicting computer comprises a first weight coefficient calculating means for reading out the maker-classified new article sales quantity or article name-classified new article sales quantity before elapsed years stored in the first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in the first data memory device, second weight coefficient calculating means for calculating the distribution color-classified weight coefficient for each distribution color according to the different distribution colors stored in the first data memory device and storing the calculated weight coefficient for each distribution color in the first data memory device, weighting means for reading out the weight coefficient based on the calculated new article sales quantity from the first data memory device and the distribution color-classified weight coefficient, multiplying the weight coefficient based on the calculated new article sales quantity by the first data memory device and the distribution color-classified weight coefficient to calculate a total weight coefficient and duplicating the number of relevant records stored in the first data memory device corresponding to the calculated total weight coefficient and storing the record numbers increased by duplicating. The category score calculating means serves to perform the aforementioned regression analysis using concurrently all the relevant records weighted by the weighting means collectively.

According to the invention, a prescribed future article residual value of an article having the same article name can be predicted by reference to a current market price valued at a used article market of an article sold in past times, thereby to comprehend a future exchange value evaluated when the used article is disposed. Particularly, the invention can concurrently and collectively deal with categorization data incapable of quantifying the factors affecting the article residual value by using a theoretical equation of multiple regression analysis based on the qualification theory I which is a superordinate concept of a common multiple regression analysis. Also, since the present invention adopts the theoretical equation derived statistical-analytically as an optimum solution to predict the article residual value, it enables the higher accurate prediction of the article residual value in comparison with the same sort of analytical method to be manually performed. Moreover, since this invention can deal with the categorization data, it is possible to cope irregular change by substituting the categorization data for quantitative data according to adequate sectionalization as long as a change in quantitative data does not necessarily cause a flat, liner change in article residual value, consequently to further increase the accuracy of the prediction.

Furthermore, in the present invention, the item category score is obtained in performing the weighting so as to find not only a value of the article but also a weight coefficient based on the new article sales quantity or both of a weight coefficient based on the new article sales quantity and a weight coefficient based on the article distribution color. Additionally, the weighting is performed by duplicating the relevant records stored in the first data memory device to increase the number of records. In a case of that the item category score is calculated by reading out various sorts of basal record data stored in the first data memory device and making a regression analysis based on the qualification theory I using the readout article residual rate proven-value as an objective variable and the readout items as explanatory variables as executed by the present invention, the weighting can be quite easily carried out by performing a weighting process to increase the record number of basal records to the number corresponding to the weighting coefficient before making the regression analysis based on the qualification theory I while dealing with all of the relevant records processed with the aforementioned weighting as samples of the regression analysis based on the qualification theory I. This is nothing more or less than software capable of establishing concrete implementation of a technical measure by making use of hardware resources of a computer.

Further, the present invention is made up of the processes of reading out the basal records stored in the first data memory device, calculating the item category score using the regression analysis based on the qualification theory I, and storing the calculated score in the second data memory device. Further, the present invention is made up of the processes of reading out the score stored in the second data memory device and calculating the article residual rate predictive-value from an equation “(article residual rate predictive-value)=(item-classified score)+(year-classified score)+(month-classified score)+(constant value)”, to obtain the article residual value with respect to the specified item category. Such a specific arithmetic processing performed by reading and writing of the data between the first and second data memory devices and the computer is nothing more or less than software capable of establishing concrete implementation of a technical measure by making use of hardware resources of a computer. In the first data memory device, the basal records to calculate the score are stored, thereby to increase the record number of the basal records by duplicating for weighting. Hence, the first data memory device stores the records to increase the record number by duplicating, and on the other hand, the second data memory device stores the score calculated on the basis of the records of the numbers increased by duplicating. So, the first data memory device and the second data memory device serve to not merely store distinctively, but also realize definite architectures set respectively therein. In this regard, the concrete implementation of a technical measure can be fulfilled by a software making use of hardware resources of a computer. Therefore, according to the present invention, the specific arithmetic processing is performed by reading and writing of the data between the first and second data memory devices and the computer by software capable of establishing the concrete implementation of the technical measure making use of hardware resources of a computer.

The article residual value predicting computer preferably comprises determination means for determining whether compensation is required for correcting a distinction in number of elapsed months attributable to an applied month, and elapsed-month number compensating means for compensating article residual rate predictive-value calculated by an article residual rate predictive-value calculating means in accordance with the average number of elapsed months for each applied month when determining that compensation is required by the determination means. In this case, it is more preferable to compose the elapsed-month number compensating means so as to perform linear interpolation of the article residual rate predictive-value in increasing or decreasing the number of elapsed years by one year in conjunction with the article residual rate predictive-value in the aforesaid number of elapsed years.

The category score calculating means is preferably provided with an elapsed year-classified record retrieving means for calculating the number of elapsed years from a difference between the year to which the used article value is applied as an explanatory variable and the model year of the article and reading out all the records corresponding to the elapsed years thus calculated from the first data memory device.

The first data memory device preferably serves to store, as one distribution color and a used article value of the used article of the distribution color, the used article value associated with the most distribution color, to store, as the distribution colors differing from one another and the used article distribution color value involved in the distribution colors, the used article value associated with the most distribution color and the used article value associated with a second-most distribution color, or to store the used article value associated with the most distribution color, the used article value associated with the second-most distribution color, and the used article value associated with third-most distribution color.

The article residual value predicting system according to the invention comprises a client-side terminal, and a server-side article residual value predicting device connected to the client-side terminal through communication network. The article residual value predicting device comprises an article residual value predicting computer, a first data memory device connected to the article residual value predicting computer to store, as basal record data, respective items such as article names, used article values for each article type, new article values for each article type, and year and month data to which the used article value is applied, a second data memory device connected to the article residual value predicting computer to store item category scores. The article residual value predicting computer comprises article residual rate proven-value calculating means for reading out the used article value and new article value for each article type stored in the first data memory device, calculating article residual rate proven-value from the ratio of the used article value to the new article value, and storing a calculated result thus obtained as an article residual rate proven-value in the first data memory device, category score calculating means for reading out the article name, article residual rate proven-value, year data to which the used article value is applied and month data to which the used article value is applied, which are stored in the first data memory device, and calculating an item category score by performing a regression analysis based on the qualification theory I using the readout article residual rate proven-value as an objective variable and the readout article name, the year to which the used article value is applied as an explanatory variable and the month to which the used article value is applied as an explanatory variable, and storing a calculated score thus obtained in the second data memory device, article residual rate predictive-value calculating means for reading out the score stored in the second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(month-classified score)+(constant value)”, and article residual rate calculating means for multiplying the article residual rate predictive-value by a new article value to calculate an article residual value. The first data memory device serves to store maker-classified new article sales quantity or article name-classified new article sales quantity before elapsed years. The article residual value predicting computer further comprises a first weight coefficient calculating means for reading out the maker-classified new article sales quantity or article name-classified new article sales quantity before elapsed years stored in the first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in the first data memory device, and weighting means for reading out the weight coefficient based on the calculated new article sales quantity from the first data memory device and duplicating the number of relevant records stored in the first data memory device corresponding to the weight coefficient based on the readout new article sales quantity and storing the record numbers increased by duplicating. The category score calculating means serves to perform the aforementioned regression analysis using concurrently all the relevant records weighted by the weighting means collectively.

Further, the article residual value predicting system according to the invention comprises a client-side terminal, and a server-side article residual value predicting device connected to the client-side terminal through communication network. The article residual value predicting device comprises an article residual value predicting computer, a first data memory device connected to the article residual value predicting computer to store, as basal record data, respective items such as article names, used article values for each article type, new article values for each article type, and year and month data to which the used article value is applied, a second data memory device connected to the article residual value predicting computer to store item category scores. The article residual value predicting computer comprises article residual rate proven-value calculating means for reading out the used article value and new article value for each article type stored in the first data memory device, calculating article residual rate proven-value from the ratio of the used article value to the new article value, and storing a calculated result thus obtained as an article residual rate proven-value in the first data memory device, category score calculating means for reading out the article name, article residual rate proven-value, year data to which the used article value is applied and month data to which the used article value is applied, which are stored in the first data memory device, and calculating an item category score by performing a regression analysis based on the qualification theory I using the readout article residual rate proven-value as an objective variable and the readout article name, the year to which the used article value is applied as an explanatory variable and the month to which the used article value is applied as an explanatory variable, and storing a calculated score thus obtained in the second data memory device, article residual rate predictive-value calculating means for reading out the score stored in the second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(month-classified score)+(constant value)”, and article residual rate calculating means for multiplying the article residual rate predictive-value by a new article value to calculate an article residual value. The first data memory device serves to store maker-classified new article sales quantity or article name-classified new article sales quantity before elapsed years, and respectively store one or more distribution colors differing from one another and used article distribution color values involved in the distribution colors. The article residual value predicting computer comprises a first weight coefficient calculating means for reading out the maker-classified new article sales quantity or article name-classified new article sales quantity before elapsed years stored in the first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in the first data memory device, second weight coefficient calculating means for calculating the distribution color-classified weight coefficient for each distribution color according to the different distribution colors stored in the first data memory device and storing the calculated weight coefficient for each distribution color in the first data memory device, weighting means for reading out the weight coefficient based on the calculated new article sales quantity from the first data memory device and the distribution color-classified weight coefficient, multiplying the weight coefficient based on the calculated new article sales quantity by the first data memory device and the distribution color-classified weight coefficient to calculate a total weight coefficient and duplicating the number of relevant records stored in the first data memory device corresponding to the calculated total weight coefficient and storing the record numbers increased by duplicating. The category score calculating means serves to perform the aforementioned regression analysis using concurrently all the relevant records weighted by the weighting means collectively.

The article residual value predicting system according to the invention further comprises a client-side terminal, and a server-side article residual value predicting device connected to the client-side terminal through communication network. This article residual value predicting device comprises an article residual value predicting computer, a first data memory device connected to the article residual value predicting computer to store, as basal record data, respective items such as article names, used article values for each article type, new article values for each article type, and year and month data to which the used article value is applied, a second data memory device connected to the article residual value predicting computer to store item category scores. The article residual value predicting computer comprises article residual rate proven-value calculating means for reading out the used article value and new article value for each article type stored in the first data memory device, calculating article residual rate proven-value from the ratio of the used article value to the new article value, and storing a calculated result thus obtained as an article residual rate proven-value in the first data memory device, category score calculating means for reading out the article name, article residual rate proven-value and year data to which the used article value is applied, which are stored in the first data memory device, and calculating an item category score by performing a regression analysis based on the qualification theory I using the readout article residual rate proven-value as an objective variable and the readout article name, and the year to which the used article value is applied as an explanatory variable, and storing a calculated score thus obtained in the second data memory device, article residual rate predictive-value calculating means for reading out the score stored in the second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(constant value)”, and article residual rate calculating means for multiplying the article residual rate predictive-value by a new article value to calculate an article residual value. The first data memory device serves to store maker-classified new article sales quantity or article name-classified new article sales quantity before elapsed years. Further, the article residual value predicting computer comprises a first weight coefficient calculating means for reading out the maker-classified new article sales quantity or article name-classified new article sales quantity before elapsed years stored in the first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in the first data memory device, weighting means for reading out the weight coefficient based on the calculated new article sales quantity from the first data memory device, duplicating the number of relevant records stored in the first data memory device corresponding to the weight coefficient based on the readout new article sales quantity and storing the record numbers increased by duplicating. The category score calculating means serves to perform the aforementioned regression analysis using concurrently all the relevant records weighted by the weighting means collectively.

Furthermore, the article residual value predicting system according to the invention comprises a client-side terminal, and a server-side article residual value predicting device connected to the client-side terminal through communication network. The article residual value predicting device comprises an article residual value predicting computer, a first data memory device connected to the article residual value predicting computer to store, as basal record data, respective items such as article names, used article values for each article type, new article values for each article type, and year data to which the used article value is applied, a second data memory device connected to the article residual value predicting computer to store item category scores. The article residual value predicting computer comprises article residual rate proven-value calculating means for reading out the used article value and new article value for each article type stored in the first data memory device, calculating article residual rate proven-value from the ratio of the used article value to the new article value, and storing a calculated result thus obtained as an article residual rate proven-value in the first data memory device, category score calculating means for reading out the article name, article residual rate proven-value and year data to which the used article value is applied, which are stored in the first data memory device, and calculating an item category score by performing a regression analysis based on the qualification theory I using the readout article residual rate proven-value as an objective variable and the readout article name, the year to which the used article value is applied as an explanatory variable, and storing a calculated score thus obtained in the second data memory device, article residual rate predictive-value calculating means for reading out the score stored in the second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(constant value)”, and article residual rate calculating means for multiplying the article residual rate predictive-value by a new article value to calculate an article residual value. The first data memory device serves to store maker-classified new article sales quantity or article name-classified new article sales quantity before elapsed years, and respectively store one or more distribution colors differing from one another and used article distribution color values involved in the distribution colors. Further, the article residual value predicting computer comprises a first weight coefficient calculating means for reading out the maker-classified new article sales quantity or article name-classified new article sales quantity before elapsed years stored in the first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in the first data memory device, second weight coefficient calculating means for calculating the distribution color-classified weight coefficient for each distribution color according to the different distribution colors stored in the first data memory device and storing the calculated weight coefficient for each distribution color in the first data memory device, weighting means for reading out the weight coefficient based on the calculated new article sales quantity from the first data memory device and the distribution color-classified weight coefficient, multiplying the weight coefficient based on the calculated new article sales quantity by the first data memory device and the distribution color-classified weight coefficient to calculate a total weight coefficient and duplicating the number of relevant records stored in the first data memory device corresponding to the calculated total weight coefficient and storing the record numbers increased by duplicating. The category score calculating means serves to perform the aforementioned regression analysis using concurrently all the relevant records weighted by the weighting means collectively.

According to the invention, a prescribed future article residual value of an article having the same article name can be predicted by reference to a current market price valued at a used article market of an article sold in past times, thereby to comprehend a future exchange value evaluated when the used article is disposed. Particularly, the invention can concurrently and collectively deal with categorization data incapable of quantifying the factors affecting the article residual value by using a theoretical equation of multiple regression analysis based on the qualification theory I which is a superordinate concept of a common multiple regression analysis. Also, since the present invention adopts the theoretical equation derived statistical-analytically as an optimum solution to predict the article residual value, it enables the higher accurate prediction of the article residual value in comparison with the same sort of analytical method to be manually performed. Moreover, since this invention can deal with the categorization data, it is possible to cope irregular change by substituting the categorization data for quantitative data according to adequate sectionalization as long as a change in quantitative data does not necessarily cause a flat, liner change in article residual value, consequently to further increase the accuracy of the prediction.

Furthermore, in the present invention, the item category score is obtained in performing the weighting so as to find not only a value of the article but also a weight coefficient based on the new article sales quantity or both of a weight coefficient based on the new article sales quantity and a weight coefficient based on the article distribution color. Additionally, the weighting is performed by duplicating the relevant records stored in the first data memory device to increase the number of records. In a case of that the item category score is calculated by reading out various sorts of basal record data stored in the first data memory device and making a regression analysis based on the qualification theory I using the readout article residual rate proven-value as an objective variable and the readout items as explanatory variables as executed by the present invention, the weighting can be quite easily carried out by performing a weighting process to increase the record number of basal records to the number corresponding to the weighting coefficient before making the regression analysis based on the qualification theory I while dealing with all of the relevant records processed with the aforementioned weighting as samples of the regression analysis based on the qualification theory I. This is nothing more or less than software capable of establishing concrete implementation of a technical measure by making use of hardware resources of a computer.

Further, the present invention is made up of the processes of reading out the basal records stored in the first data memory device, calculating the item category score using the regression analysis based on the qualification theory I, and storing the calculated score in the second data memory device. Further, the present invention is made up of the processes of reading out the score stored in the second data memory device and calculating the article residual rate predictive-value from an equation “(article residual rate predictive-value)=(item-classified score)+(year-classified score)+(month-classified score)+(constant value)”, to obtain the article residual value with respect to the specified item category. Such a specific arithmetic processing performed by reading and writing of the data between the first and second data memory devices and the computer is nothing more or less than software capable of establishing concrete implementation of a technical measure by making use of hardware resources of a computer. In the first data memory device, the basal records to calculate the score are stored, thereby to increase the record number of the basal records by duplicating for weighting. Hence, the first data memory device stores the records to increase the record number by duplicating, and on the other hand, the second data memory device stores the score calculated on the basis of the records of the numbers increased by duplicating. So, the first data memory device and the second data memory device serve to not merely store distinctively, but also realize definite architectures set respectively therein. In this regard, the concrete implementation of a technical measure can be fulfilled by a software making use of hardware resources of a computer. Therefore, according to the present invention, the specific arithmetic processing is performed by reading and writing of the data between the first and second data memory devices and the computer by software capable of establishing the concrete implementation of the technical measure making use of hardware resources of a computer.

The article residual value predicting in the article residual value predicting device computer preferably comprises determination means for determining whether compensation is required for correcting a distinction in number of elapsed months attributable to an applied month, and elapsed-month number compensating means for compensating article residual rate predictive-value calculated by an article residual rate predictive-value calculating means in accordance with the average number of elapsed months for each applied month when determining that compensation is required by the determination means. In this case, it is more preferable to compose the elapsed-month number compensating means so as to perform linear interpolation of the article residual rate predictive-value in increasing or decreasing the number of elapsed years by one year in conjunction with the article residual rate predictive-value in the aforesaid number of elapsed years.

The category score calculating means in the article residual value predicting device is preferably provided with an elapsed year-classified record retrieving means for calculating the number of elapsed years from a difference between the year to which the used article value is applied as an explanatory variable and the model year of the article and reading out all the records corresponding to the elapsed years thus calculated from the first data memory device.

The first data memory device in the article residual value predicting device preferably serves to store, as one distribution color and a used article value of the used article of the distribution color, the used article value associated with the most distribution color, to store, as the distribution colors differing from one another and the used article distribution color value involved in the distribution colors, the used article value associated with the most distribution color and the used article value associated with a second-most distribution color, or to store the used article value associated with the most distribution color, the used article value associated with the second-most distribution color, and the used article value associated with third-most distribution color.

The car residual value predicting device of the invention comprises a car residual value predicting computer, a first data memory device connected to the car residual value predicting computer to store, as basal record data, respective items such as car names, used car values for each car type, new car values for each car type, and year and month data to which the used car value is applied, a second data memory device connected to the car residual value predicting computer to store item category scores. The car residual value predicting computer comprises car residual rate proven-value calculating means for reading out the used car value and new car value for each car type stored in the first data memory device, calculating car residual rate proven-value from the ratio of the used car value to the new car value, and storing a calculated result thus obtained as a car residual rate proven-value in the first data memory device, category score calculating means for reading out the car name, car residual rate proven-value, year data to which the used car value is applied and month data to which the used car value is applied, which are stored in the first data memory device, and calculating an item category score by performing a regression analysis based on the qualification theory I using the readout car residual rate proven-value as an objective variable and the readout car name, the year to which the used car value is applied as an explanatory variable and the month to which the used car value is applied as an explanatory variable, and storing a calculated score thus obtained in the second data memory device, car residual rate predictive-value calculating means for reading out the score stored in the second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(month-classified score)+(constant value)”, and car residual rate calculating means for multiplying the car residual rate predictive-value by a new car value to calculate a car residual value. The first data memory device serves to store maker-classified new car sales quantity or car name-classified new car sales quantity before elapsed years. The car residual value predicting computer further comprises a first weight coefficient calculating means for reading out the maker-classified new car sales quantity or car name-classified new car sales quantity before elapsed years stored in the first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in the first data memory device, and weighting means for reading out the weight coefficient based on the calculated new car sales quantity from the first data memory device and duplicating the number of relevant records stored in the first data memory device corresponding to the weight coefficient based on the readout new car sales quantity and storing the record numbers increased by duplicating. The category score calculating means serves to perform the aforementioned regression analysis using concurrently all the relevant records weighted by the weighting means collectively. The term ‘car name’ here represents the name assigned to a car by a car maker, and the term ‘car type’ represents unit pieces subdivided according to model year, approval type, car grade, shift indicating transmission type, car type describing the number of doors and a body shape, engine displacement and distribution color with respect to each car name.

The car residual value predicting device comprises a car residual value predicting computer, a first data memory device connected to the car residual value predicting computer to store, as basal record data, respective items such as car names, used car values for each car type, new car values for each car type, and year and month data to which the used car value is applied, a second data memory device connected to the car residual value predicting computer to store item category scores. The car residual value predicting computer comprises car residual rate proven-value calculating means for reading out the used car value and new car value for each car type stored in the first data memory device, calculating car residual rate proven-value from the ratio of the used car value to the new car value, and storing a calculated result thus obtained as a car residual rate proven-value in the first data memory device, category score calculating means for reading out the car name, car residual rate proven-value, year data to which the used car value is applied and month data to which the used car value is applied, which are stored in the first data memory device, and calculating an item category score by performing a regression analysis based on the qualification theory I using the readout car residual rate proven-value as an objective variable and the readout car name, the year to which the used car value is applied as an explanatory variable and the month to which the used car value is applied as an explanatory variable, and storing a calculated score thus obtained in the second data memory device, car residual rate predictive-value calculating means for reading out the score stored in the second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(month-classified score)+(constant value)”, and car residual rate calculating means for multiplying the car residual rate predictive-value by a new car value to calculate a car residual value. The first data memory device serves to store maker-classified new car sales quantity or car name-classified new car sales quantity before elapsed years, and respectively store one or more distribution colors differing from one another and used car distribution color values involved in the distribution colors. Further, the car residual value predicting computer comprises a first weight coefficient calculating means for reading out the maker-classified new car sales quantity or car name-classified new car sales quantity before elapsed years stored in the first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in the first data memory device, second weight coefficient calculating means for calculating the distribution color-classified weight coefficient for each distribution color according to the different distribution colors stored in the first data memory device and storing the calculated weight coefficient for each distribution color in the first data memory device, weighting means for reading out the weight coefficient based on the calculated new car sales quantity from the first data memory device and the distribution color-classified weight coefficient, multiplying the weight coefficient based on the calculated new car sales quantity by the first data memory device and the distribution color-classified weight coefficient to calculate a total weight coefficient and duplicating the number of relevant records stored in the first data memory device corresponding to the calculated total weight coefficient and storing the record numbers increased by duplicating. The category score calculating means serves to perform the aforementioned regression analysis using concurrently all the relevant records weighted by the weighting means collectively.

Furthermore, the car residual value predicting device comprises a car residual value predicting computer, a first data memory device connected to the car residual value predicting computer to store, as basal record data, respective items such as car names, used car values for each car type, new car values for each car type, and year data to which the used car value is applied, a second data memory device connected to the car residual value predicting computer to store item category scores. The car residual value predicting computer comprises car residual rate proven-value calculating means for reading out the used car value and new car value for each car type stored in the first data memory device, calculating car residual rate proven-value from the ratio of the used car value to the new car value, and storing a calculated result thus obtained as a car residual rate proven-value in the first data memory device, category score calculating means for reading out the car name, car residual rate proven-value, and year data to which the used car value is applied, which are stored in the first data memory device, and calculating an item category score by performing a regression analysis based on the qualification theory I using the readout car residual rate proven-value as an objective variable and the readout car name, and the year to which the used car value is applied as an explanatory variable, and storing a calculated score thus obtained in the second data memory device, car residual rate predictive-value calculating means for reading out the score stored in the second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(constant value)”, and car residual rate calculating means for multiplying the car residual rate predictive-value by a new car value to calculate a car residual value. The first data memory device serves to store maker-classified new car sales quantity or car name-classified new car sales quantity before elapsed years. The car residual value predicting computer further comprises a first weight coefficient calculating means for reading out the maker-classified new car sales quantity or car name-classified new car sales quantity before elapsed years stored in the first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in the first data memory device, and weighting means for reading out the weight coefficient based on the calculated new car sales quantity from the first data memory device and duplicating the number of relevant records stored in the first data memory device corresponding to the weight coefficient based on the readout new car sales quantity and storing the record numbers increased by duplicating. The category score calculating means serves to perform the aforementioned regression analysis using concurrently all the relevant records weighted by the weighting means collectively.

The car residual value predicting device comprises a car residual value predicting computer, a first data memory device connected to the car residual value predicting computer to store, as basal record data, respective items such as car names, used car values for each car type, new car values for each car type, and year data to which the used car value is applied, a second data memory device connected to the car residual value predicting computer to store item category scores. The car residual value predicting computer comprises car residual rate proven-value calculating means for reading out the used car value and new car value for each car type stored in the first data memory device, calculating car residual rate proven-value from the ratio of the used car value to the new car value, and storing a calculated result thus obtained as a car residual rate proven-value in the first data memory device, category score calculating means for reading out the car name, car residual rate proven-value, and year data to which the used car value is applied, which are stored in the first data memory device, and calculating an item category score by performing a regression analysis based on the qualification theory I using the readout car residual rate proven-value as an objective variable and the readout car name, and the year to which the used car value is applied as an explanatory variable, and storing a calculated score thus obtained in the second data memory device, car residual rate predictive-value calculating means for reading out the score stored in the second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(constant value)”, and car residual rate calculating means for multiplying the car residual rate predictive-value by a new car value to calculate a car residual value. The first data memory device serves to store maker-classified new car sales quantity or car name-classified new car sales quantity before elapsed years, and respectively store one or more distribution colors differing from one another and used car distribution color values involved in the distribution colors. Further, the car residual value predicting computer comprises a first weight coefficient calculating means for reading out the maker-classified new car sales quantity or car name-classified new car sales quantity before elapsed years stored in the first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in the first data memory device, second weight coefficient calculating means for calculating the distribution color-classified weight coefficient for each distribution color according to the different distribution colors stored in the first data memory device and storing the calculated weight coefficient for each distribution color in the first data memory device, weighting means for reading out the weight coefficient based on the calculated new car sales quantity from the first data memory device and the distribution color-classified weight coefficient, multiplying the weight coefficient based on the calculated new car sales quantity by the first data memory device and the distribution color-classified weight coefficient to calculate a total weight coefficient and duplicating the number of relevant records stored in the first data memory device corresponding to the calculated total weight coefficient and storing the record numbers increased by duplicating. The category score calculating means serves to perform the aforementioned regression analysis using concurrently all the relevant records weighted by the weighting means collectively.

According to the invention, a prescribed future car residual value of a car having the same car name can be predicted by reference to a current market price valued at a used car market of a car sold in past times, thereby to comprehend a future exchange value evaluated when the used car is disposed. Particularly, the invention can concurrently and collectively deal with categorization data incapable of quantifying the factors affecting the car residual value by using a theoretical equation of multiple regression analysis based on the qualification theory I which is a superordinate concept of a common multiple regression analysis. Also, since the present invention adopts the theoretical equation derived statistical-analytically as an optimum solution to predict the car residual value, it enables the higher accurate prediction of the car residual value in comparison with the same sort of analytical method to be manually performed. Moreover, since this invention can deal with the categorization data, it is possible to cope irregular change by substituting the categorization data for quantitative data according to adequate sectionalization as long as a change in quantitative data does not necessarily cause a flat, liner change in car residual value, consequently to further increase the accuracy of the prediction.

Furthermore, in the present invention, the item category score is obtained in performing the weighting so as to find not only a value of the car but also a weight coefficient based on the new car sales quantity or both of a weight coefficient based on the new car sales quantity and a weight coefficient based on the car distribution color. Additionally, the weighting is performed by duplicating the relevant records stored in the first data memory device to increase the number of records. In a case of that the item category score is calculated by reading out various sorts of basal record data stored in the first data memory device and making a regression analysis based on the qualification theory I using the readout car residual rate proven-value as an objective variable and the readout items as explanatory variables as executed by the present invention, the weighting can be quite easily carried out by performing a weighting process to increase the record number of basal records to the number corresponding to the weighting coefficient before making the regression analysis based on the qualification theory I while dealing with all of the relevant records processed with the aforementioned weighting as samples of the regression analysis based on the qualification theory I. This is nothing more or less than software capable of establishing concrete implementation of a technical measure by making use of hardware resources of a computer.

Further, the present invention is made up of the processes of reading out the basal records stored in the first data memory device, calculating the item category score using the regression analysis based on the qualification theory I, and storing the calculated score in the second data memory device. Further, the present invention is made up of the processes of reading out the score stored in the second data memory device and calculating the car residual rate predictive-value from an equation “(car residual rate predictive-value)=(item-classified score)+(year-classified score)+(month-classified score)+(constant value)” or “(car residual rate predictive-value)=(item-classified score)+(year-classified score)+(constant value)”, to obtain the car residual value with respect to the specified item category. Such a specific arithmetic processing performed by reading and writing of the data between the first and second data memory devices and the computer is nothing more or less than software capable of establishing concrete implementation of a technical measure by making use of hardware resources of a computer. In the first data memory device, the basal records to calculate the score are stored, thereby to increase the record number of the basal records by duplicating for weighting. Hence, the first data memory device stores the records to increase the record number by duplicating, and on the other hand, the second data memory device stores the score calculated on the basis of the records of the numbers increased by duplicating. So, the first data memory device and the second data memory device serve to not merely store distinctively, but also realize definite architectures set respectively therein. In this regard, the concrete implementation of a technical measure can be fulfilled by a software making use of hardware resources of a computer. Therefore, according to the present invention, the specific arithmetic processing is performed by reading and writing of the data between the first and second data memory devices and the computer by software capable of establishing the concrete implementation of the technical measure making use of hardware resources of a computer.

The car residual value predicting computer preferably comprises determination means for determining whether compensation is required for correcting a distinction in number of elapsed months attributable to an applied month, and elapsed-month number compensating means for compensating car residual rate predictive-value calculated by a car residual rate predictive-value calculating means in accordance with the average number of elapsed months for each applied month when determining that compensation is required by the determination means. In this case, it is more preferable to compose the elapsed-month number compensating means so as to perform linear interpolation of the car residual rate predictive-value in increasing or decreasing the number of elapsed years by one year in conjunction with the car residual rate predictive-value in the aforesaid number of elapsed years.

The car type is preferably stipulated according to the model year, approval type, car grade, shift indicating transmission type, car type describing the number of doors and a body shape, engine displacement and distribution color for each car name.

The category score calculating means is preferably provided with an elapsed year-classified record retrieving means for calculating the number of elapsed years from a difference between the year to which the used car value is applied as an explanatory variable and the model year of the car and reading out all the records corresponding to the elapsed years thus calculated from the first data memory device.

The first data memory device preferably serves to store, as one distribution color and a used car value of the used car of the distribution color, the used car value associated with the most distribution color, to store, as the distribution colors differing from one another and the used car distribution color value involved in the distribution colors, the used car value associated with the most distribution color and the used car value associated with a second-most distribution color, or to store the used car value associated with the most distribution color, the used car value associated with the second-most distribution color, and the used car value associated with third-most distribution color.

The car residual value predicting system according to the invention comprises a client-side terminal, and a server-side car residual value predicting device connected to the client-side terminal through communication network. The car residual value predicting device comprises a car residual value predicting computer, a first data memory device connected to the car residual value predicting computer to store, as basal record data, car names, used car values for each car type, new car values for each car type, and year and month data to which the used car value is applied, a second data memory device connected to the car residual value predicting computer to store item category scores. The car residual value predicting computer comprises car residual rate proven-value calculating means for reading out the used car value and new car value for each car type stored in the first data memory device, calculating car residual rate proven-value from the ratio of the used car value to the new car value, and storing a calculated result thus obtained as a car residual rate proven-value in the first data memory device, category score calculating means for reading out the car name, car residual rate proven-value, year data to which the used car value is applied and month data to which the used car value is applied, which are stored in the first data memory device, and calculating an item category score by performing a regression analysis based on the qualification theory I using the readout car residual rate proven-value as an objective variable and the readout car name, the year to which the used car value is applied as an explanatory variable and the month to which the used car value is applied as an explanatory variable, and storing a calculated score thus obtained in the second data memory device, car residual rate predictive-value calculating means for reading out the score stored in the second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(month-classified score)+(constant value)”, and car residual rate calculating means for multiplying the car residual rate predictive-value by a new car value to calculate a car residual value. The first data memory device serves to store maker-classified new car sales quantity or car name-classified new car sales quantity before elapsed years. The car residual value predicting computer further comprises a first weight coefficient calculating means for reading out the maker-classified new car sales quantity or car name-classified new car sales quantity before elapsed years stored in the first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in the first data memory device, and weighting means for reading out the weight coefficient based on the calculated new car sales quantity from the first data memory device and duplicating the number of relevant records stored in the first data memory device corresponding to the weight coefficient based on the readout new car sales quantity and storing the record numbers increased by duplicating. The category score calculating means serves to perform the aforementioned regression analysis using concurrently all the relevant records weighted by the weighting means collectively.

Further, the car residual value predicting system according to the invention comprises a client-side terminal, and a server-side car residual value predicting device connected to the client-side terminal through communication network. The car residual value predicting device comprises a car residual value predicting computer, a first data memory device connected to the car residual value predicting computer to store, as basal record data, respective items such as car names, used car values for each car type, new car values for each car type, and year and month data to which the used car value is applied, a second data memory device connected to the car residual value predicting computer to store item category scores. The car residual value predicting computer comprises car residual rate proven-value calculating means for reading out the used car value and new car value for each car type stored in the first data memory device, calculating car residual rate proven-value from the ratio of the used car value to the new car value, and storing a calculated result thus obtained as a car residual rate proven-value in the first data memory device, category score calculating means for reading out the car name, car residual rate proven-value, year data to which the used car value is applied and month data to which the used car value is applied, which are stored in the first data memory device, and calculating an item category score by performing a regression analysis based on the qualification theory I using the readout car residual rate proven-value as an objective variable and the readout car name, the year to which the used car value is applied as an explanatory variable and the month to which the used car value is applied as an explanatory variable, and storing a calculated score thus obtained in the second data memory device, car residual rate predictive-value calculating means for reading out the score stored in the second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(month-classified score)+(constant value)”, and car residual rate calculating means for multiplying the car residual rate predictive-value by a new car value to calculate a car residual value. The first data memory device serves to store maker-classified new car sales quantity or car name-classified new car sales quantity before elapsed years, and respectively store one or more distribution colors differing from one another and used car distribution color values involved in the distribution colors. Further, the car residual value predicting computer comprises a first weight coefficient calculating means for reading out the maker-classified new car sales quantity or car name-classified new car sales quantity before elapsed years stored in the first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in the first data memory device, second weight coefficient calculating means for calculating the distribution color-classified weight coefficient for each distribution color according to the different distribution colors stored in the first data memory device and storing the calculated weight coefficient for each distribution color in the first data memory device, weighting means for reading out the weight coefficient based on the calculated new car sales quantity from the first data memory device and the distribution color-classified weight coefficient, multiplying the weight coefficient based on the calculated new car sales quantity by the first data memory device and the distribution color-classified weight coefficient to calculate a total weight coefficient and duplicating the number of relevant records stored in the first data memory device corresponding to the calculated total weight coefficient and storing the record numbers increased by duplicating. The category score calculating means serves to perform the aforementioned regression analysis using concurrently all the relevant records weighted by the weighting means collectively.

Furthermore, the car residual value predicting system according to the invention comprises a client-side terminal, and a server-side car residual value predicting device connected to the client-side terminal through communication network. The car residual value predicting device comprises a car residual value predicting computer, a first data memory device connected to the car residual value predicting computer to store, as basal record data, respective items such as car names, used car values for each car type, new car values for each car type, and year data to which the used car value is applied, a second data memory device connected to the car residual value predicting computer to store item category scores. The car residual value predicting computer comprises car residual rate proven-value calculating means for reading out the used car value and new car value for each car type stored in the first data memory device, calculating car residual rate proven-value from the ratio of the used car value to the new car value, and storing a calculated result thus obtained as a car residual rate proven-value in the first data memory device, category score calculating means for reading out the car name, car residual rate proven-value, and year data to which the used car value is applied, which are stored in the first data memory device, and calculating an item category score by performing a regression analysis based on the qualification theory I using the readout car residual rate proven-value as an objective variable and the readout car name, and the year to which the used car value is applied as an explanatory variable, and storing a calculated score thus obtained in the second data memory device, car residual rate predictive-value calculating means for reading out the score stored in the second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(constant value)”, and car residual rate calculating means for multiplying the car residual rate predictive-value by a new car value to calculate a car residual value. The first data memory device serves to store maker-classified new car sales quantity or car name-classified new car sales quantity before elapsed years. The car residual value predicting computer further comprises a first weight coefficient calculating means for reading out the maker-classified new car sales quantity or car name-classified new car sales quantity before elapsed years stored in the first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in the first data memory device, and weighting means for reading out the weight coefficient based on the calculated new car sales quantity from the first data memory device and duplicating the number of relevant records stored in the first data memory device corresponding to the weight coefficient based on the readout new car sales quantity and storing the record numbers increased by duplicating. The category score calculating means serves to perform the aforementioned regression analysis using concurrently all the relevant records weighted by the weighting means collectively.

Further, the car residual value predicting system according to the invention comprises a client-side terminal, and a server-side car residual value predicting device connected to the client-side terminal through communication network. The car residual value predicting device comprises a car residual value predicting computer, a first data memory device connected to the car residual value predicting computer to store, as basal record data, respective items such as car names, used car values for each car type, new car values for each car type, and year and month data to which the used car value is applied, a second data memory device connected to the car residual value predicting computer to store item category scores. The car residual value predicting computer comprises car residual rate proven-value calculating means for reading out the used car value and new car value for each car type stored in the first data memory device, calculating car residual rate proven-value from the ratio of the used car value to the new car value, and storing a calculated result thus obtained as a car residual rate proven-value in the first data memory device, category score calculating means for reading out the car name, car residual rate proven-value, and year data to which the used car value is applied, which are stored in the first data memory device, and calculating an item category score by performing a regression analysis based on the qualification theory I using the readout car residual rate proven-value as an objective variable and the readout car name, and the year to which the used car value is applied as an explanatory variable, and storing a calculated score thus obtained in the second data memory device, car residual rate predictive-value calculating means for reading out the score stored in the second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(constant value)”, and car residual rate calculating means for multiplying the car residual rate predictive-value by a new car value to calculate a car residual value. The first data memory device serves to store maker-classified new car sales quantity or car name-classified new car sales quantity before elapsed years, and respectively store one or more distribution colors differing from one another and used car distribution color values involved in the distribution colors. Further, the car residual value predicting computer comprises a first weight coefficient calculating means for reading out the maker-classified new car sales quantity or car name-classified new car sales quantity before elapsed years stored in the first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in the first data memory device, second weight coefficient calculating means for calculating the distribution color-classified weight coefficient for each distribution color according to the different distribution colors stored in the first data memory device and storing the calculated weight coefficient for each distribution color in the first data memory device, weighting means for reading out the weight coefficient based on the calculated new car sales quantity from the first data memory device and the distribution color-classified weight coefficient, multiplying the weight coefficient based on the calculated new car sales quantity by the first data memory device and the distribution color-classified weight coefficient to calculate a total weight coefficient and duplicating the number of relevant records stored in the first data memory device corresponding to the calculated total weight coefficient and storing the record numbers increased by duplicating. The category score calculating means serves to perform the aforementioned regression analysis using concurrently all the relevant records weighted by the weighting means collectively.

According to the invention, a prescribed future car residual value of a car having the same car name can be predicted by reference to a current market price valued at a used car market of a car sold in past times, thereby to comprehend a future exchange value evaluated when the used car is disposed. Particularly, the invention can concurrently and collectively deal with categorization data incapable of quantifying the factors affecting the car residual value by using a theoretical equation of multiple regression analysis based on the qualification theory I which is a superordinate concept of a common multiple regression analysis. Also, since the present invention adopts the theoretical equation derived statistical-analytically as an optimum solution to predict the car residual value, it enables the higher accurate prediction of the car residual value in comparison with the same sort of analytical method to be manually performed. Moreover, since this invention can deal with the categorization data, it is possible to cope irregular change by substituting the categorization data for quantitative data according to adequate sectionalization as long as a change in quantitative data does not necessarily cause a flat, liner change in car residual value, consequently to further increase the accuracy of the prediction.

Furthermore, in the present invention, the item category score is obtained in performing the weighting so as to find not only a value of the car but also a weight coefficient based on the new car sales quantity or both of a weight coefficient based on the new car sales quantity and a weight coefficient based on the car distribution color. Additionally, the weighting is performed by duplicating the relevant records stored in the first data memory device to increase the number of records. In a case of that the item category score is calculated by reading out various sorts of basal record data stored in the first data memory device and making a regression analysis based on the qualification theory I using the readout car residual rate proven-value as an objective variable and the readout items as explanatory variables as executed by the present invention, the weighting can be quite easily carried out by performing a weighting process to increase the record number of basal records to the number corresponding to the weighting coefficient before making the regression analysis based on the qualification theory I while dealing with all of the relevant records processed with the aforementioned weighting as samples of the regression analysis based on the qualification theory I. This is nothing more or less than software capable of establishing concrete implementation of a technical measure by making use of hardware resources of a computer.

Further, the present invention is made up of the processes of reading out the basal records stored in the first data memory device, calculating the item category score using the regression analysis based on the qualification theory I, and storing the calculated score in the second data memory device. Further, the present invention is made up of the processes of reading out the score stored in the second data memory device and calculating the car residual rate predictive-value from an equation “(car residual rate predictive-value)=(item-classified score)+(year-classified score)+(month-classified score)+(constant value)”, to obtain the car residual value with respect to the specified item category. Such a specific arithmetic processing performed by reading and writing of the data between the first and second data memory devices and the computer is nothing more or less than software capable of establishing concrete implementation of a technical measure by making use of hardware resources of a computer. In the first data memory device, the basal records to calculate the score are stored, thereby to increase the record number of the basal records by duplicating for weighting. Hence, the first data memory device stores the records to increase the record number by duplicating, and on the other hand, the second data memory device stores the score calculated on the basis of the records of the numbers increased by duplicating. So, the first data memory device and the second data memory device serve to not merely store distinctively, but also realize definite architectures set respectively therein. In this regard, the concrete implementation of a technical measure can be fulfilled by a software making use of hardware resources of a computer. Therefore, according to the present invention, the specific arithmetic processing is performed by reading and writing of the data between the first and second data memory devices and the computer by software capable of establishing the concrete implementation of the technical measure making use of hardware resources of a computer.

The car residual value predicting computer in the car residual value predicting device preferably comprises determination means for determining whether compensation is required for correcting a distinction in number of elapsed months attributable to an applied month, and elapsed-month number compensating means for compensating car residual rate predictive-value calculated by a car residual rate predictive-value calculating means in accordance with the average number of elapsed months for each applied month when determining that compensation is required by the determination means. In this case, it is more preferable to compose the elapsed-month number compensating means so as to perform linear interpolation of the car residual rate predictive-value in increasing or decreasing the number of elapsed years by one year in conjunction with the car residual rate predictive-value in the aforesaid number of elapsed years.

The car type is preferably stipulated according to the model year, approval type, car grade, shift indicating transmission type, car type describing the number of doors and a body shape, engine displacement and distribution color for each car name.

The category score calculating means in the car residual value predicting device is preferably provided with an elapsed year-classified record retrieving means for calculating the number of elapsed years from a difference between the year to which the used car value is applied as an explanatory variable and the model year of the car and reading out all the records corresponding to the elapsed years thus calculated from the first data memory device.

The first data memory device in the car residual value predicting device preferably serves to store, as one distribution color and a used car value of the used car of the distribution color, the used car value associated with the most distribution color, to store, as the distribution colors differing from one another and the used car distribution color value involved in the distribution colors, the used car value associated with the most distribution color and the used car value associated with a second-most distribution color, or to store the used car value associated with the most distribution color, the used car value associated with the second-most distribution color, and the used car value associated with third-most distribution color.

### EFFECT OF THE INVENTION

According to the invention, a prescribed future article residual value of an article having the same article name or future car residual value of a car having the same car name can be predicted by reference to a current market price valued at a used article market of an article or a used car market of a car sold in past times, so that a future exchange value evaluated when the used article or used car is disposed can be comprehended, and further, it can be predicted by means of the theoretical equation derived statistical-analytically as an optimum solution. Also, since the present invention adopts the theoretical equation derived statistical-analytically as an optimum solution to predict the residual value, it enables the higher accurate prediction of the article residual value or car residual value in comparison with the same sort of analytical method to be manually performed. Moreover, since this invention can deal with the categorization data, it is possible to cope irregular change by substituting the categorization data for quantitative data according to adequate sectionalization as long as a change in quantitative data does not necessarily cause a flat, liner change in article residual value or car residual value, consequently to further increase the accuracy of the prediction.

Further, according to the invention, since the number of records stored is increased by duplicating the records, consequently to perform weighting by increasing the number of samples subject to regression analysis, the weighting can be quite easily carried out.

### BRIEF DESCRIPTION OF THE DRAWINGS

FIG. 1 is a block diagram schematically illustrating the overall structure of an article residual value predicting system as one embodiment of the present invention.

FIG. 2 is a block diagram schematically illustrating the functional structure of a car residual value predicting computer in the embodiment of FIG. 1.

FIG. 3 is a flowchart schematically illustrating a part of the program of the car residual value predicting computer in the embodiment of FIG. 1.

FIG. 4 is a flowchart schematically illustrating a part of the program of the car residual value predicting computer in the embodiment of FIG. 1.

FIG. 5 is a diagram showing a part of basal records actually provided in Blue Book data.

FIG. 6 is a diagram illustrative of an example of the record stored correspondingly in the first data memory device in the embodiment of FIG. 1.

FIG. 7 is a diagram illustrative of an example of increase in record according to the number of distribution color in the embodiment of FIG. 1.

FIG. 8 is a diagram exemplifying a weight coefficient for each distribution color in the embodiment of FIG. 1.

FIG. 9 is a diagram illustrative of a weighting process with the weight coefficient for each distribution color of FIG. 8.

FIG. 10 is a diagram illustrative of item, item category and calculated score obtained in the embodiment of FIG. 1.

FIG. 11 is a graph illustrative of score in each of item categories on car name obtained in the embodiment of FIG. 1.

FIG. 12 is a graph illustrative of score in each of item categories on applied year obtained in the embodiment of FIG. 1.

FIG. 13 is a graph illustrative of score in each of item categories on applied month obtained in the embodiment of FIG. 1.

FIG. 14 is a graph illustrative of average number of months elapsed since new car went on sale, which exerts an influence on a used car value, in a case where the used car value in the embodiment of FIG. 1 is evaluated at three elapsed years.

FIG. 15 is a flowchart schematically illustrating a part of the program of the car residual value predicting computer in another embodiment of FIG. 1.

### EXPLANATION OF REFERENCE NUMERALS

10 Car residual value predicting device
10a Communication control unit
10b Car residual value predicting computer
10b₁ Elapsed year-classified record retrieving means
10b₂ Record-number increasing means
10b₃ Car residual rate proven-value calculating means
10b₄ First weight coefficient calculating means
10b₅ Second weight coefficient calculating means
10b₆ Weighting means
10b₇ Category score calculating means
10b₈ Car residual rate predictive-value calculating means
10b₉ Car residual rate calculating means
10b₁₀ Elapsed-month number compensating means
10c First data memory device
10d Second data memory device
11 Communication network
12 Client-side terminal

### BEST MODE FOR CARRYING OUT THE INVENTION

Hereinafter, preferred embodiments of a car residual value predicting system according to the present invention will be described in detail with reference to the accompanying drawings. Although the car residual value predicting system will be explained here as one embodiment of the invention, it will be obvious that this invention can be applied to an article residual value predicting system for dealing with, for instance, electric appliance such as personal computers (PC) and domestic articles by replacing the car with an article in the system.

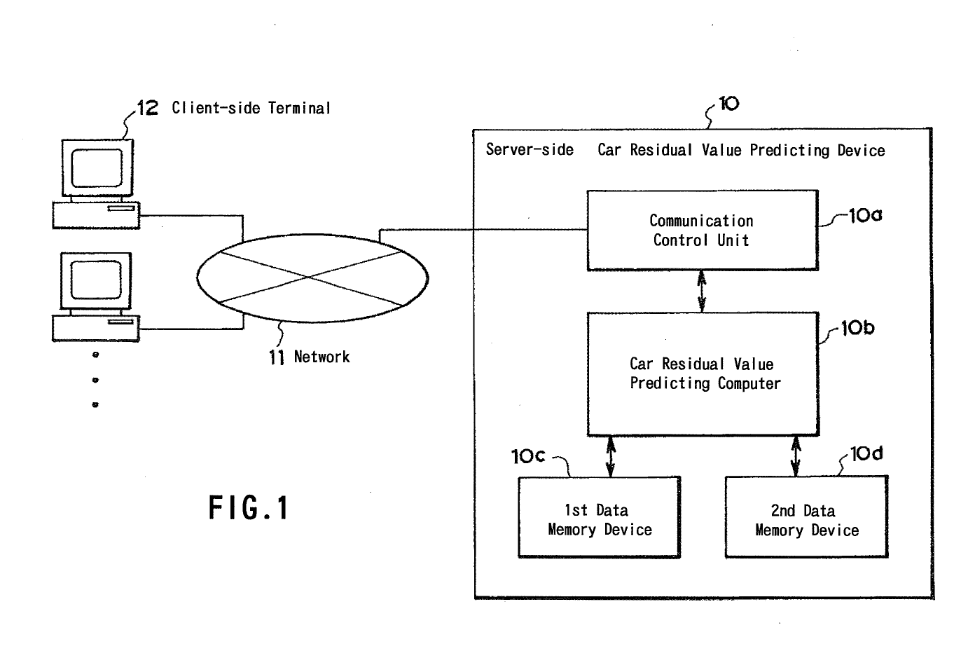

FIG. 1 is a block diagram schematically illustrating the overall structure of an article residual value predicting system as one embodiment of the present invention. This embodiment is concerned with the car residual value predicting system suitable for use in car leasing business.

As shown in FIG. 1, a server-side car residual value predicting device 10 is connected to a plurality of client-side terminals 12 through communication network 11 such as local area network (LAN), Internet or dedicated network. For instance, the system may be established by a main personal computer (PC) as a server and terminals as clients connected thereto through LAN, or a computer installed at the headquarters as the server and terminals at each of branches. The car residual value predicting device 10 may of course be operated independently without being connected to the network 11.

The client-side terminal 12 is formed by a computer, keyboard, mouse and display, and has a communication function capable of being connected to the communication network 11. The client-side terminal 12 may be constructed to establish a user interface by a program such as WEB browser in communicating with the server.

The server-side car residual value predicting device 10 is provided with at least a communication control unit 10a for controlling network communication, a car residual value predicting computer 10b, a first data memory device 10c and a second data memory device 10d.

Although not shown, the car residual value predicting computer 10b comprises ROM storing an operating system (OS), CPU for executing various programs, and RAM serving as work areas for various processing functions, so as to process data transmitted and received between itself and the communication control unit 10a, read and write data stored in databases formed by the first data memory device 10c and the second data memory device 10d, and execute the program stored in the ROM.

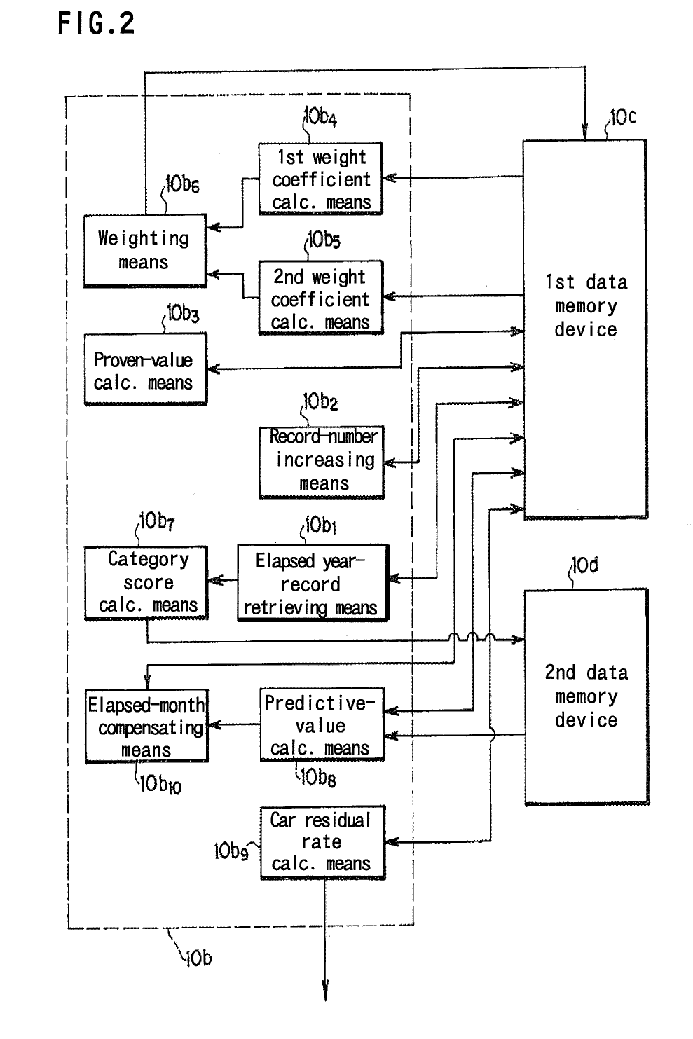

FIG. 2 is a block diagram schematically illustrating the functional structure of a car residual value predicting computer in the embodiment of FIG. 1.

As shown in FIG. 1, the car residual value predicting computer 10b comprises elapsed year-classified record retrieving means 10b₁ for calculating the equation (number of elapsed years)=(year to which the used car value is applied)/(model year) to read out the year corresponding to the number of elapsed years from the first data memory device 10c, record-number increasing means 10b₂ for increasing the number of records stored in the first data memory device 10c according to distribution colors differing from one another, car residual rate proven-value calculating means 10b₃ for calculating the equation (car residual rate proven-value)=(used car value)/(new car value), first weight coefficient calculating means 10b₄ for calculating the equation (weight coefficient based on new car sales quantity)=(maker-classified new car sales quantity before elapsed years)/(maker-classified record number), second weight coefficient calculating means 10b₅ for calculating a distribution color-classified weight coefficient for each distribution color according to the different distribution colors incorporated in the basal record, weighting means 10b₆ for calculating the equation (total weight coefficient)=(weight coefficient based on the calculated new car sales quantity)×(weight coefficient for each distribution color) and duplicating the records stored in the first data memory device 10c to increase the number of records, category score calculating means 10b₇ for performing a regression analysis based on the qualification theory I using a car residual rate proven-value as an objective variable and respective items such as car name, the year to which the used car value is applied as an explanatory variable to calculate item category scores (score for each of item categories), car residual rate predictive-value calculating means 10b₈ for calculating the equation (car residual rate predictive-value)=(item-classified score)+(year-classified score)+(month-classified score)+(constant value) on the basis of the score for a specified item category, car residual rate calculating means 10b₉ for calculating the equation (car residual value)=(car residual rate predictive-value)×(new car value), and elapsed-month number compensating means 10b₁₀ for compensating the car residual rate predictive-value in accordance with the average number of elapsed months for each applied month when requiring compensation for correcting a distinction in average number of elapsed months attributable to an applied month.

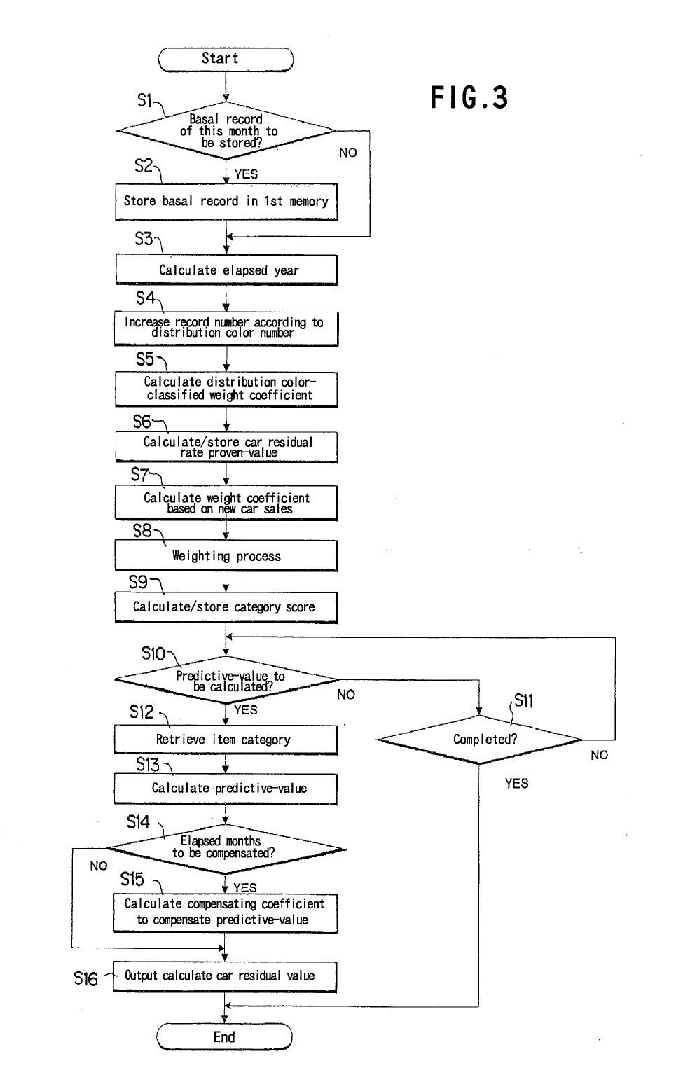

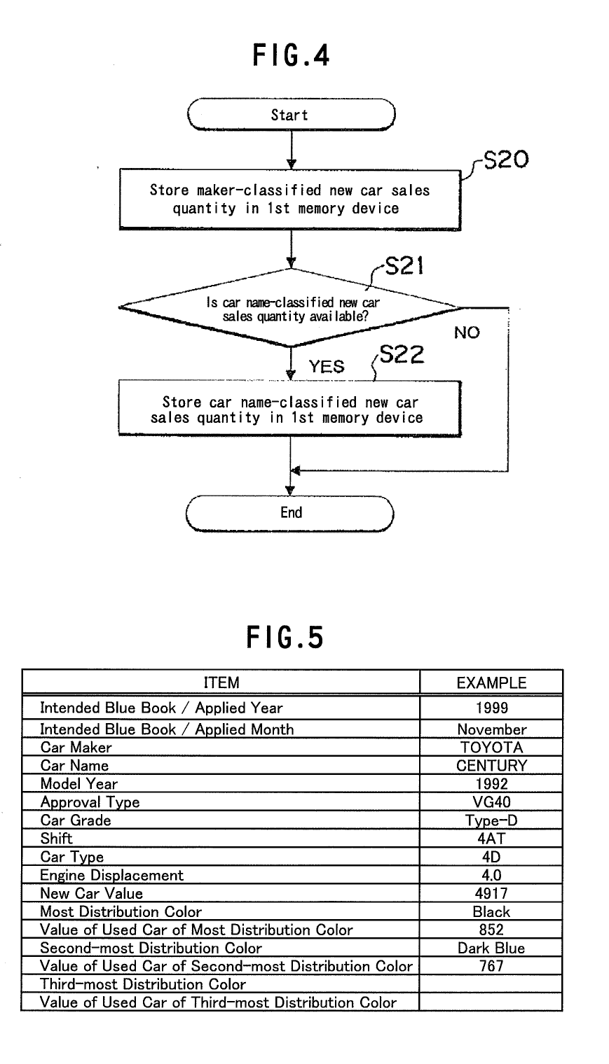

FIG. 3 and FIG. 4 are flowcharts schematically illustrating a part of the program of the car residual value predicting computer 10b. The processing procedure of the car residual value predicting computer 10b will be described hereinafter with reference to these figures.

As shown in FIG. 3, first, determination as to whether the basal record of this month has to be recorded is made (Step S1). When the recording is required (in the case of “YES”), the basal record of this month is added to the basal record up to the previous month end and stored in the first data memory device 10c (Step S2). Hence, in the first data memory device 10c, there are stored the basal record data including respective items of at least the year to which the used car value, month to which the used car value, car maker, car name, model year, approval type, car grade, shift, car type, engine displacement, new car price, distribution color, used car price involved in distribution color.

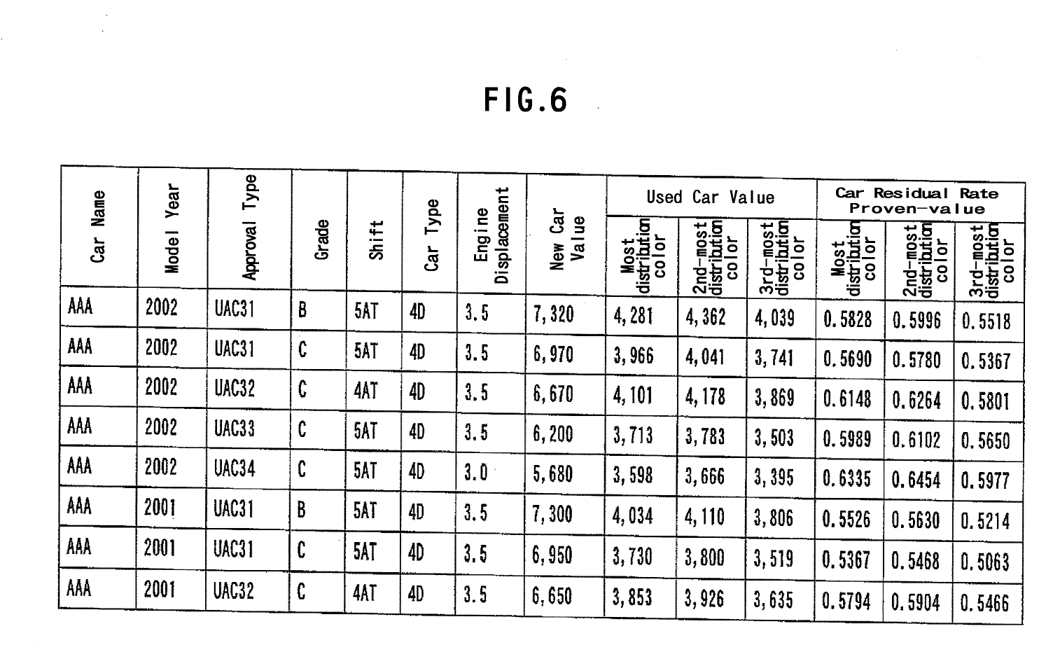

As shown in FIG. 6, the basal records described here are formed of different records according to the model year, approval type, car grade, shift, car type and engine displacement even if the items of car name are the same. The basal record contains one, two or three distribution colors, but it is increased in number by duplicating the distribution color-classified record to define the car type-classified record. The car name item is used as an explanatory variable in the regression analysis based on the qualification theory I, but the car type-classified record is dealt with as a sample record having the same car name item. The sample record is subjected to a weighting process with a total weight coefficient obtained by multiplying a weight coefficient based on new car sales quantity by a distribution color-classified weight coefficient, thereby to increase the number of records. The case where no weighting is performed has the same meaning as that having a weight coefficient of 1.0 uniformly per record.

The basal record has the same meaning as a record available to the public in a used-car price guide book (e.g. Blue Book data published by Proto Corporation) used in trading used cars. The Blue Book data were obtained by invariably screening data of actually proven car auction performance and includes car maker, car name, model year, approval type, car grade, shift indicating transmission type, car type representing the number of doors and body shape, engine displacement, distribution color, and used car value with respect to each distribution color item. The Blue Book data are provided to users on the Web or in some other way. Updating of the basal record based on the used-car price guide book is manually carried out by a server administrator or automatically through remote network, or it may be done by means other than it. The “record” is formed of an aggregate of items and corresponds to a “line” in the Blue Book data. Therefore, “one record” is equivalent to “one line” in the Blue Book data.

As shown in FIG. 5, each item in the basal record actually provided in the Blue Book data is composed of applied year of the intended Blue Book data on domestic cars (year when price of a used car is calculated), applied month of the intended Blue Book data on domestic cars (month when a used car price is calculated), car maker (car maker destined for calculation of the used car price), car name (car name destined for calculation of the used car price), model year (model year destined for calculation of the used car price), approval type (approval type destined for calculation of the used car price), car grade (car grade destined for calculation of the used car price), shift (transmission type destined for calculation of the used car price), car type (the number of car doors or body shape destined for calculation of the used car price), shift (transmission type destined for calculation of the used car price), engine displacement (engine displacement destined for calculation of the used car price; Unit: 1000 cc), new car value (launch price recommended by a car maker on the used car destined for calculation of the used car price; Unit: 1000 Japanese Yen), most distribution color (body color of the most selling car in the relevant car type), used car value of most distribution color (price of the used car of most distribution color; Unit: 1000 Japanese Yen), second-most distribution color (body color of the second-most selling car in the relevant car type), used car value of second-most distribution color (price of the used car of second-most distribution color car; Unit: 1000 Japanese Yen), third-most distribution color (body color of the third-most selling car in the relevant car type), and used car value of third-most distribution color (price of the used car of third-most distribution color car; Unit: 1000 Japanese Yen).

As shown in FIG. 4, maker-classified new car sales quantity is stored in the first data memory device 10c in another routine (Step S20). Subsequently, determination as to whether car name-classified new car sales quantity is available is made (Step S21). When it is available (in the case of “YES”), the car name-classified new car sales quantity is stored in the first data memory device 10c (Step S22). Hence, annual new car sales quantity for each car maker or both of the annual new car sales quantity for each car maker and car name-classified new car sales quantity are stored in the first data memory device 10c. The annual new car sales quantity for each car maker and car name-classified new car sales quantity are generally published in newspapers every year.

On the other hand, as shown in FIG. 3, an arithmetic processing of the following formula is performed in an elapsed year-classified record retrieving means 10b₁ to calculate elapsed years, so that the records in every item categories corresponding to the calculated elapsed years can be read out from the first data memory device 10c (Step S3).

Elapsed years=(Year to which used car value is applied)/(Model year) (1)

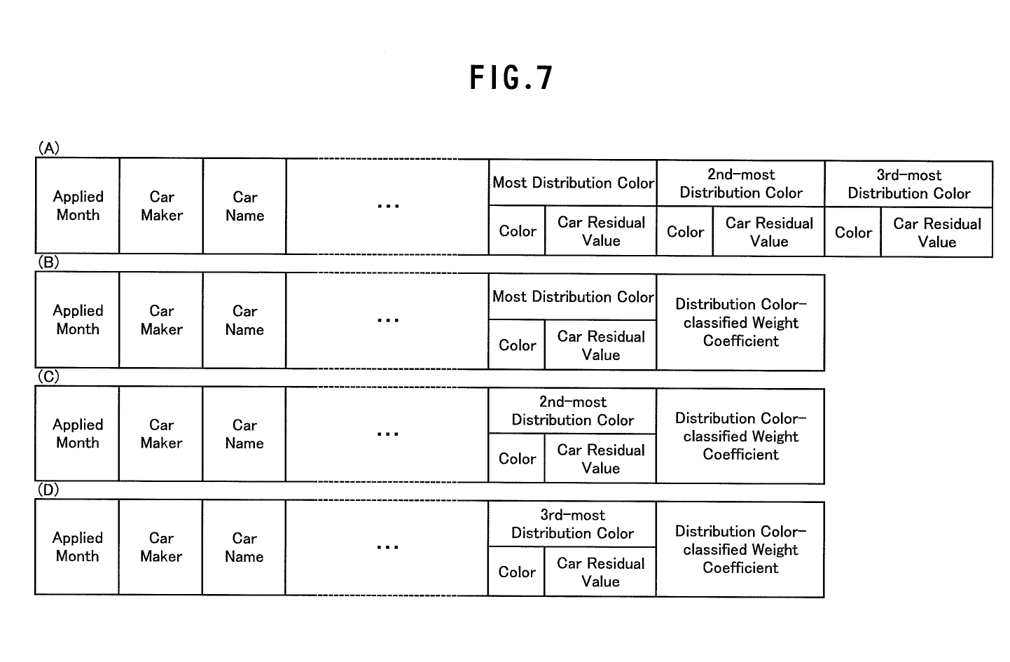

Next, the number of records stored in the first data memory device 10c is increased according to the different distribution color included in the basal record by the record-number increasing means 10b₂ (Step S4). That is, in the first data memory device 10c in this embodiment, as shown in FIG. 7(A), pairs of colors relevant to three distribution colors and car residual rate proven-value, i.e. the most distribution color and car residual rate proven-value, the second-most distribution color and car residual rate proven-value and the third-most distribution color and car residual rate proven-value are stored in pairs as one record, thus to increase in number to three records and delete the original record, as shown in FIGS. 7(B), 7(C) and 7(D). In cases where the number of distribution colors is two, that is, when the one record is a pair of the most distribution color and car residual rate proven-value and the second-most distribution color and car residual rate proven-value, the record is increased in number to two records, and the original record is deleted, as shown in FIGS. 7(B) and 7(C). Four or more pairs of distribution colors and car residual rate proven-values may possibly be used according to used-car price guide books as reference. However, in a case of one distribution color, that is, when there is one pair of the most distribution color and car residual rate proven-value, the record shown in FIG. 7(B) is generated and the original record is deleted.

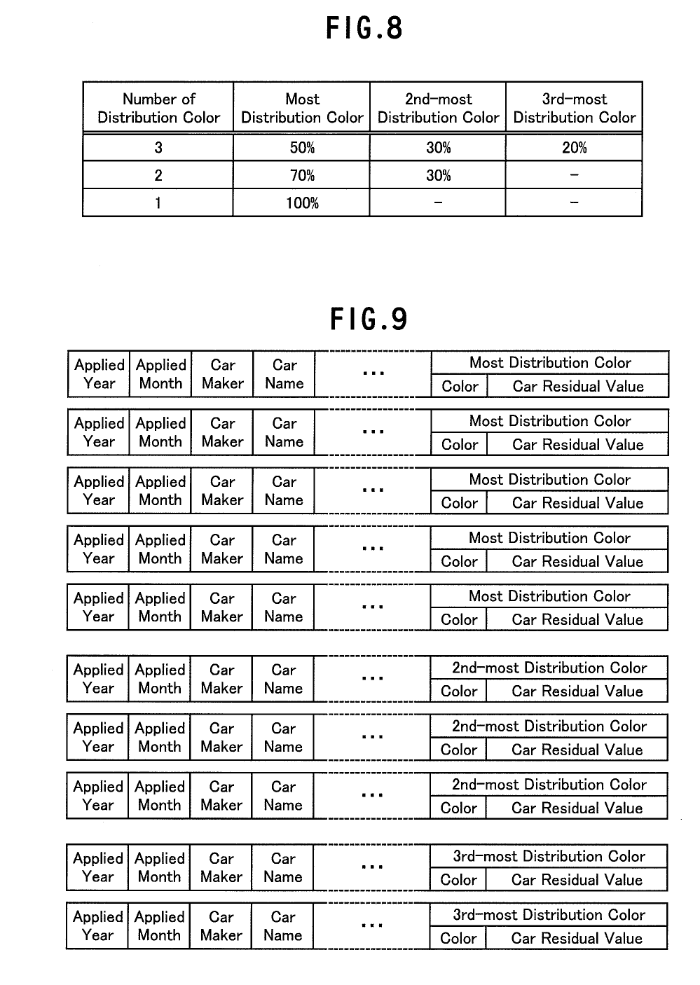

Next, a distribution color-classified weight coefficient is calculated by the second weight coefficient calculating means 10b₅ according to the number of different distribution colors included in the basal record, i.e. depending on how many different distribution colors are included and whether the number of cars of the relevant distribution colors is large or small (Step S5). That is, the first data memory device 10c is referred to in order to assign the weight coefficient to the most distribution color, the second-most distribution color and the third-most distribution color for each distribution color according to the number of distribution colors and giving priority to the distribution number of cars with the most distribution number. In this case, the closest number to the realities of distribution number of the cars of each distribution color should be adopted, but, when no authoritative actual distribution number exists, admeasurement as shown in FIG. 8 may be specified as one example.

In the embodiment of FIG. 8, when the distribution color number is 3, the most distribution color becomes 30%, the second-most distribution color becomes 50% and the third-most distribution color becomes 20%, totaling 100% in distribution color number. In this case, as to the calculated distribution color-classified weight coefficient, as shown in FIGS. 7(B), 7(C) and 7(D), when the total coefficient of the distribution colors is 1, the coefficient of the most distribution color becomes 0.5, that of the second-most distribution color becomes 0.3, and that of the most distribution color becomes 0.2. These coefficients of the distribution colors are incrementally stored in the first data memory device 10c. When the distribution color number is 2 of the most distribution color and the second-most distribution color, the most distribution color becomes 70%, and the second-most distribution color becomes 30%, totaling 100% in distribution color number. When the distribution color number is 1 of the most distribution color, the most distribution color becomes 100%. The distribution color-classified weight coefficient shown in FIG. 8 is just one example and should not be understood as limitative, but it is set to a higher value in the order of the most distribution color, second-most distribution color and third-most distribution color. At any rate, the total distribution color coefficient becomes invariably 100%.

Next, the used car value for each car type and the new car value for the same car type both stored in the first data memory device 10c are read out by the car residual rate proven-value calculating means 10b₃ to calculate the car residual rate proven-value by means of the equation: (car residual rate proven-value)=(used car value of the relevant car)/(new car value of the relevant car)/(Step S6). The calculated car residual rate proven-value is added in item to the first data memory device 10c as an objective variable with respect to each car type. Namely, the following arithmetic processing expressed by the following equation (2) is performed to set the car residual rate proven-value as the objective variable as defined by the equation (3).

(Car residual rate proven-value)=(Used car value)/(New car value) (2)

(Objective variable)=(Car residual rate proven-value) (3)

Here, the price of the car residual value itself is not predicted directly as a final objective, but the car residual rate proven-value is first predicted.

That is, as shown partially in FIG. 6, in the first data memory device 10c, every items of car maker, car name, model year, approval type, grade, shift (transmission type), car type, engine displacement, new car value, used car value of most distribution color, used car value of second-most distribution color, used car value of third-most distribution color are stored correspondingly to one another with respect to each year and month to which the used car value (year and month of issuance of the Blue Book data). Further, the car residual rate proven-value of most distribution color, the items of the car residual rate proven-value of second-most distribution color and the car residual rate proven-value of third-most distribution color are added and stored therein.

Next, the maker-classified new car sales quantity before elapsed years is read out and subjected to the arithmetic processing expressed by the following equation (4) by the first weight coefficient calculating means 10b₄ to calculate the weight coefficient based on new car sales quantity (Step S7).

(Weight coefficient based on new car sales quantity)=(maker-classified new car sales quantity before elapsed years)/(Maker-classified record number) (4)

That is, in the first data memory device 10c, the maker-classified new car sales quantity before elapsed years, which is stored at Step S20 shown in FIG. 4, is read out and divided by the maker-classified record number corresponding to the elapsed years stored in the first data memory device 10c and obtained by the elapsed year-classified record retrieving means 10b₁ to calculate a weight coefficient based on car sales quantity per maker-classified record obtained as the result of the division process. To explain it with an example, when the maker-classified new car sales quantity of a maker “A” is 3000 and the maker-classified record number is 30, the weight coefficient based on new car sales quantity of the maker “A” becomes 100, provided it is the record number before increasing the record number according to the distribution color number.

In such a usual case, the weight coefficient based on new car sales quantity is obtained by dividing the maker-classified new car sales quantity before elapsed years by the maker-classified record number, but in some cases of domestic cars which are published on car name-classified new car sales quantity before elapsed years (in the case where the car name-classified new car sales quantity is stored at Step S22 in FIG. 4), the weight coefficient based on new car sales quantity is calculated by the following equation (5) using the car name-classified record number corresponding to the elapsed years stored in the first data memory device 10c and obtained by the elapsed year-classified record retrieving means 10b₁. That is the following arithmetic processing is performed.

(Weight coefficient based on new car sales quantity)=(Car name-classified new car sales quantity before elapsed years)/(Car name-classified record number) (5)

However, in both cases that the weight coefficient based on new car sales quantity is obtained by the equation (4) or the equation (5), the weight coefficient based on new car sales quantity should be set to 1 or larger. For instance, when the car name-classified new car sales quantity of a car name “AAA” is 600 and the car name-classified record number is 10, the weight coefficient based on new car sales quantity of a car name “AAA” becomes 60.

Next, a total weight coefficient is calculated from the weight coefficient based on new car sales quantity and distribution color-classified weight coefficient by performing the following equation (6) by the weighting means 10b₆ to increase the record number of the records stored in the first data memory device 10c on the basis of the total weight coefficient (Step S8).

(Total weight coefficient)=(Weight coefficient based on new car sales quantity)/(Distribution color-classified weight coefficient) (6)

The process for weighting by increase in record number will be described hereinafter. As one example, the case where the weigh coefficient corresponds to the distribution color-classified weight coefficient when the number of distribution colors is 3 will be explained. In this case, the distribution color-classified weight coefficients assume values as shown in FIGS. 7(B)/(C) and (D) as described above. By duplicating the contents of the record stored in the first data memory device 10c according to the respective weight coefficients, the record number is turned into an object of a regression analysis based on the qualification theory I as described later, in which the increased total number corresponding to the weight coefficient is used as a proven record. To be specific, the total number is turned as the proven record into the object of the after-mentioned regression analysis based on the qualification theory I by increasing the record number of the most distribution color to 5, the record number of the second-most distribution color to 3 and the record number of the third-most distribution color to 2. Thus, the score weighted for each of item categories is obtained by performing the regression analysis based on the qualification theory I after changing the record number stored in the first data memory device 10c to change the sample number. As described later, since a regression equation in this regression analysis is calculated by means of a least-squares method, the largely increased record has a much more significant influence on the regression equation than the little increased record.

Although the weighting in this embodiment is carried out by obtaining the total weight coefficient from the weight coefficient based on new car sales quantity and distribution color-classified weight coefficient, the weighting may be carried out by using only the weight coefficient based on new car sales quantity. In this case, the record number may be increased by duplicating the record according to the weight coefficient based on new car sales quantity, or, in the case where the total weight coefficient is calculated, the same values with respect to all the distribution colors may be used as the distribution color-classified weight coefficient.

Next, an item category score is calculated by performing the regression analysis based on the qualification theory I by the category score calculating means 10b₇ (Step S9). That is, the regression analysis based on the qualification theory I is performed using items of the car name, applied year and applied month (item categories) read out from the first data memory device 10c as explanatory variables and a car residual rate proven-value as an objective variable to calculate the item category score and then store it to the second data memory device 10d. Incidentally, in this embodiment, the item category number of the car name is 124, the item category number of the applied year is 7, and the item category number of the applied month is 12.

The qualification theory I is a transfiguration of a multiple regression analysis which is made by converting explanatory variables of categorization data into explanatory variables of quantitative data assuming only 0 or 1 and subjecting the explanatory variables of all the categorization data to the same process. For instance, as an example of the explanatory variable of the categorization data classified to four categories, blood group will be explained. In this case, the blood groups A, B, AB and O are defined by a combination of three quantitative explanatory variables represented respectively by the binary digits 1 and 0. That is, by expressing the blood groups A, B, AB and O by (1,0,0)/(0,1,0)/(0,0,1) and (0,0,0), the explanatory variable is increased from 1 to 3, but can be converted to the quantitative explanatory variable. This conversion is called a digital conversion. The multiple regression analysis is made by performing the conversion for all the explanatory variables of category type. In this embodiment of the invention, since the explanatory variables are increased voluminously in number, so that it is almost impossible to explain a process of finding a category score, i.e. coefficient of a regression equation, a method for finding the coefficients a, b and c of the regression equation in the multiple regression analysis using two explanatory variables will be described hereinafter.

Given that the regression equation for finding theoretical value ŷ is ŷ=a+bx₁+cx₂, the coefficients a, b and c are evaluated by the least-squares method so as to minimize the sum of the square of an error which is a difference between the theoretical value ŷ and the proven-value y. The sum Se of the square of the error is given by the following equation, where n is the number of samples.

$$\begin{matrix}Se = \sum {( \hat{y} - y )}^{2} \\ = \sum {( ( a + {bx}_{1} + {cx}_{2} ) - y )}^{2} \\ = \sum {y}^{2} - 2 \sum y ( a + {bx}_{1} + {cx}_{2} ) + \sum {( a + {bx}_{1} + {cx}_{2} )}^{2} \\ = \sum {y}^{2} - 2 a \sum y - 2 b \sum {x}_{1} y - 2 c \sum {yx}_{2} + {na}^{2} + {b}^{2} \sum {x}_{1}^{2} + \\ {c}^{2} \sum {x}_{2}^{2} + 2 ab \sum {x}_{1} + 2 ac \sum {x}_{2} + 2 bc \sum {x}_{1} {x}_{2}\end{matrix}$$

In order to minimize the sum Se, the desired a, b and c are obtained by solving simultaneous equations deriving (∂S/∂a=0)/(∂S/∂b=0) and (∂S/∂c=0) differentiated partially with a, b and c on the right side of the equation.

To be specific, the following equation is held.

∂S/∂a=−2Σy+2na+2bΣx₁+2cΣx₂=0

∂S/∂b=−2Σx₁y+2bΣx₁²+2aΣx₁+2cΣx₁x₂=0

∂S/∂c=−2Σyx₂+2cΣx₂²+2aΣx₂+2bΣx₁x₂=0

Given that an average of y, x₁ and x₂ are y̅, x̅₁ and x̅₂, respectively, the following equation is satisfied.

$$na = \sum y - b \sum {x}_{1} - c \sum {x}_{2}$$

$$\begin{matrix}n \sum {x}_{1} y = nb \sum {x}_{1}^{2} + na \sum {x}_{1} + nc \sum {x}_{1} {x}_{2} \\ = nb \sum {x}_{1}^{2} + ( \sum y - b \sum {x}_{1} - c \sum {x}_{2} ) \sum {x}_{1} + \\ nc \sum {x}_{1} {x}_{2}\end{matrix}$$

$$\begin{matrix}n \sum {x}_{1} y - \sum {x}_{1} \sum y = b ( n \sum {x}_{1}^{2} - {( \sum {x}_{1} )}^{2} ) + c ( n \sum {x}_{1} {x}_{2} - \\ \sum {x}_{1} \sum {x}_{2} )\end{matrix}$$

$$\sum ( {x}_{1} - {\overline{x}}_{1} ) ( y - \overline{y} ) = b \sum {( {x}_{1} - {\overline{x}}_{1} )}^{2} + c \sum ( {x}_{1} - {\overline{x}}_{1} ) ( {x}_{2} - {\overline{x}}_{2} )$$

$$\sum ( {x}_{2} - {\overline{x}}_{2} ) ( y - \overline{y} ) = b \sum {( {x}_{2} - {\overline{x}}_{2} )}^{2} + c \sum ( {x}_{1} - {\overline{x}}_{1} ) ( {x}_{2} - {\overline{x}}_{2} ) \\ \\$$

Where the following relations are held,

S_{1y}=Σ(x₁− x̅₁)(y− y̅)

S_{2y}=Σ(x₂− x̅₂)(y− y̅)

S₁₁=Σ(x₁− x̅₁)²

S₂₂=Σ(x₂− x̅₂)²

S₁₂=Σ(x₁− x̅₁)(x₂− x̅₂)

the following relation equations are obtained.

b=(S_{1y}S₂₂−S_{2y}S₁₂)/(S₁₁S₂₂−S₁₂²)

c=(S_{1y}−bS₁₁)/S₁₂

a= y̅−b x̅₁−c x̅₂

The regression analysis based on the qualification in this embodiment involving a lot of explanatory variables make use of the function of the qualification theory I of S-PLUS which is a typical statistics software to obtain the category score.

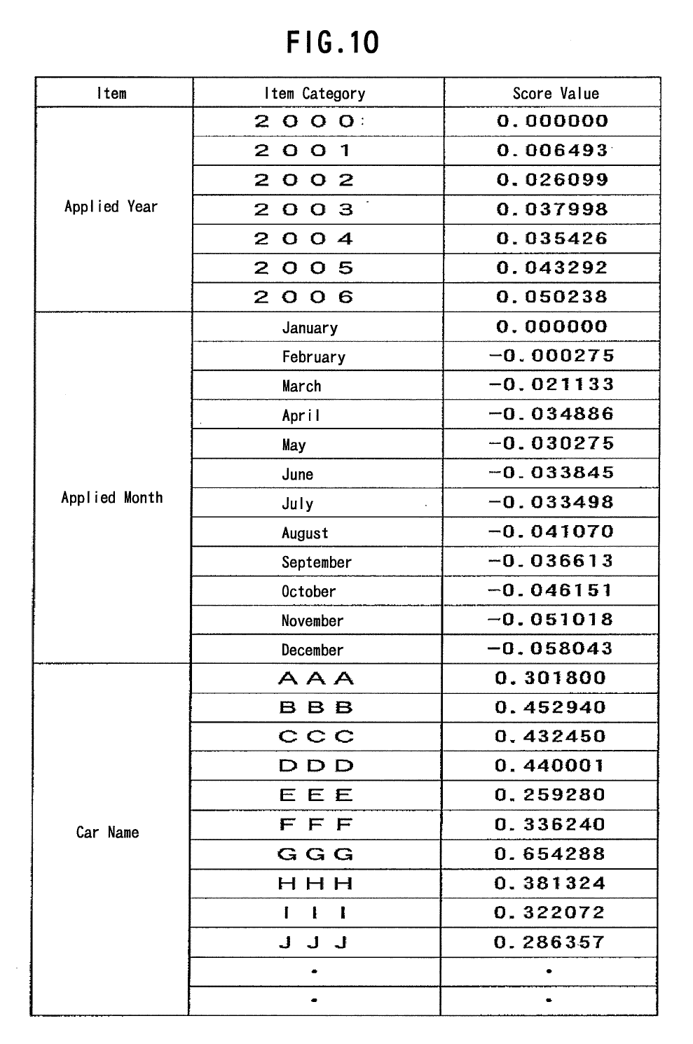

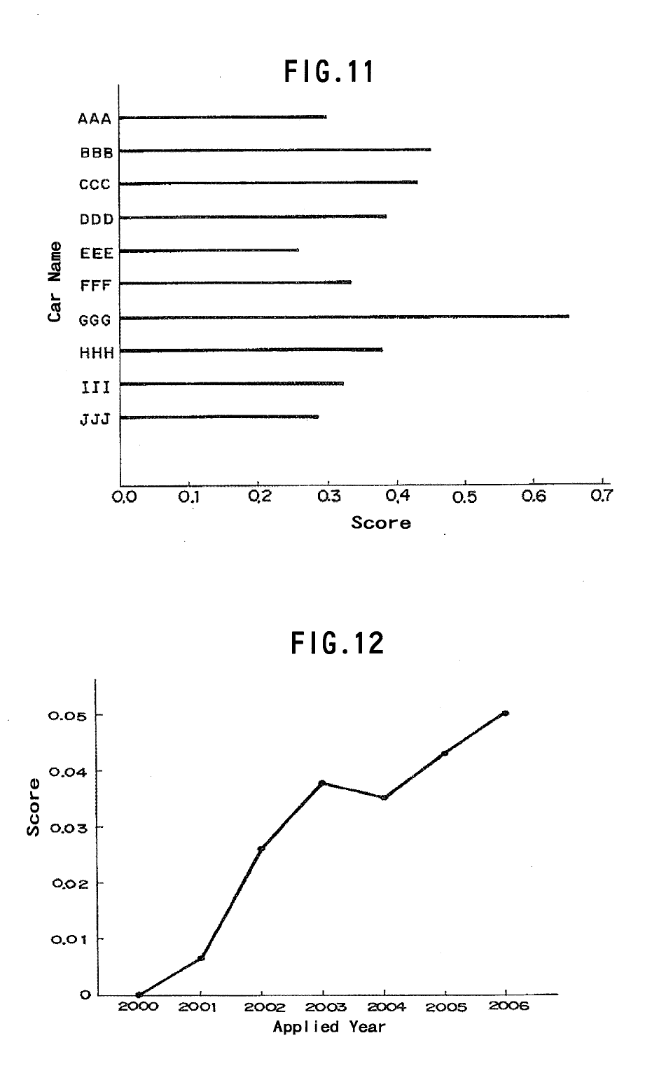

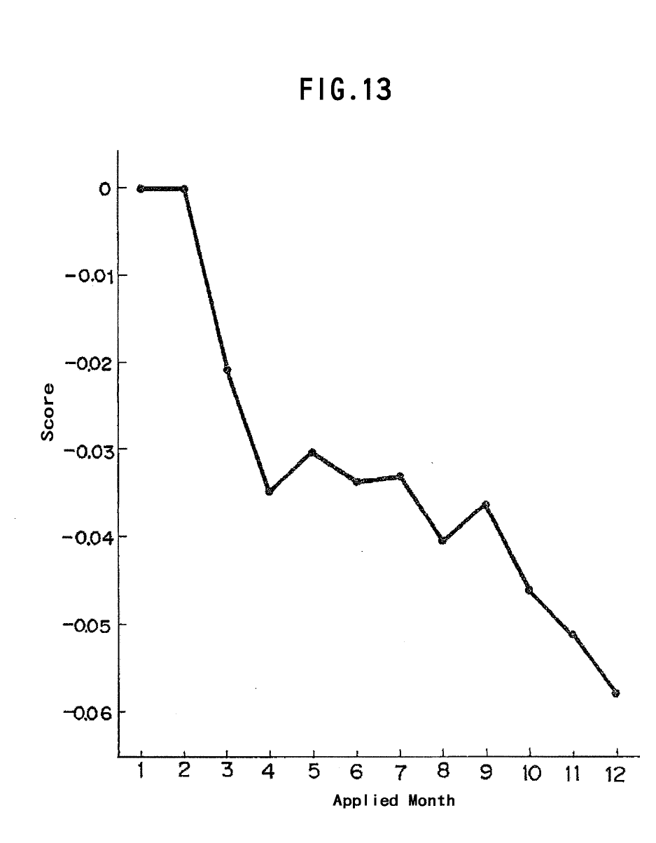

FIG. 10 illustrates one example of the item category score which is calculated by performing the regression analysis based on the qualification theory I and stored in the second data memory device 10d in the embodiment of the invention. FIG. 11 through FIG. 13 are bar and polygonal line graphs showing the score. The score relevant to the car name is depicted with the addition of intercept score 0.3018 (constant) calculated coincidentally.

Subsequently, determination as to whether the car residual rate predictive-value is calculated or not on the basis of the theoretical equation thus obtained is made (Step S10). When determining that the car residual rate predictive-value is not calculated (in the case of “NO”), upon determining whether all the processes are completed or not is made (Step S11), determination as to whether the process should be actually completed or calculation of the predictive value should be performed is repeated.

In the case of calculating the car residual rate predictive-value (in the case of “YES”), the item category of the car name, applied year and applied month with respect to a car to be predicted is retrieved (Step S12). As one example, the item category indicating that the car name of the relevant car is “AAA”, the applied year is the year of 2007, and the applied month is the month of October is retrieved.

Next, the score corresponding to the item category thus retrieved is read out from the second data memory device 10d by the car residual rate predictive-value calculating means 10b₈, and the car residual rate predictive-value is calculated using the year-classified score relative to the year at some future point to be predicted, e.g. year-classified score of the nearest year (Step S13).

To be specific, an arithmetic processing according to the following equation (7) is performed.

(Car residual rate predictive-value)=(Car name-classified score)+(Year-classified score)+(Month-classified score)+(Constant value) (7)

There is adopted here the year-classified score of a predictive-value for the year at some future point to be predicted, namely, the year-classified score of the nearest year in view of an upward trend in this embodiment of the invention. The year-classified score obtained with the trend or an average value may be used.

Next, determination as to whether compensation is required for correcting a distinction in number of elapsed months attributable to an applied month is made by the elapsed-month number compensating means 10b₁₀ (Step S14). In car leasing business, in the case of a 3 years' lease, the compensation for difference in average number of elapsed months due to the applied month is required to conform a lease term to the course of 36 months.

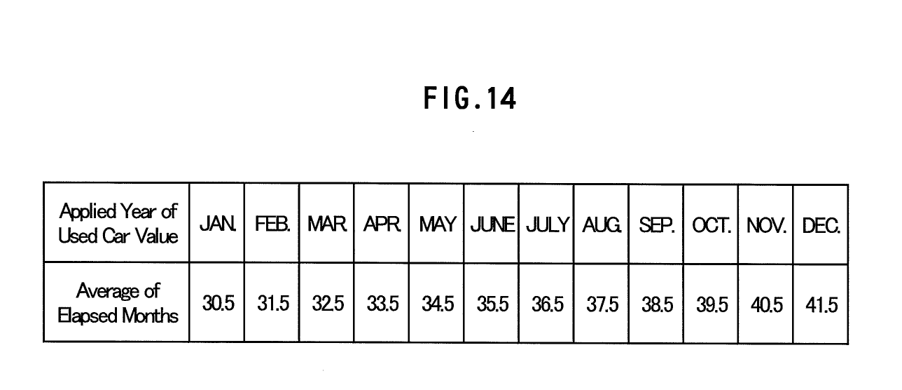

When requiring compensation (in the case of “YES”), upon calculating a compensating coefficient according to the average number of elapsed months for each applied month by the elapsed-month number compensating means 10b₁₀, compensation is made by multiplying the car residual rate predictive-value calculated at Step S12 by the compensating coefficient (Step S15). As described above, in the case where the number of elapsed years is obtained by the equation (number of elapsed years)=(year to which the used car value is applied)/(model year), it turns out that even the same model year has a range from January to December. Also, even the Blue Book data exhibits the issuance month (applied month) having the range from January to December. It is found that the car residual rate predictive-value differs in average number of elapsed months from new car sales according to the month to which the used car value is applied as indicated by “Case at three elapsed years is taken for one example” in FIG. 14. However, in FIG. 14, the average number of elapsed months (month unit) is enumerated for the respective applied months for used car value (from January to December). As shown in FIG. 14, 3 elapsed years as of the current applied month of January is within the range of 36 months to 25 months, that is, 30.5 elapsed months on an average. In the case of predicting the car residual value just after three years have passed, 4 elapsed years (3 years+1 year) becomes 42.5 elapsed months likewise, so as to calculate the predictive-value just at 36 elapsed years with linear interpolation between the predictive-value with respect to the 3 elapsed years and the predictive-value with respect to the 4 elapsed years. To be specific, assuming that the compensating coefficient is W, there is found W=(42.5−36)/12=0.542 by solving 36=30.5×W+42.5×(1−W). The car residual rate predictive-value compensated with a weighted average is obtained by multiplying the compensating coefficients W and (1−W) by the car residual rate predictive-value of the 3 elapsed years and the predictive-value of the 4 elapsed years, respectively.

When the compensation is determined to be unnecessary at Step S14 (in the case of “NO”), the process advances to Step S16 as it is.

At Step S16, the car residual rate predictive-value calculated at Step S13 or the car residual rate predictive-value compensated at Step S15 is multiplied by the new car value of the relevant car to calculate the car residual value to be given to a predicting operator.

Namely, the following equation (8) is performed.

(Car residual value)=(New car value)×(Car residual rate predictive-value) (8)

When the predicting operator requires a predicting process by use of the car residual value predicting computer 10b on the server side, the car residual rate predictive-value is outputted from the computer. Alternatively, when the predicting operator requires a predicting process by use of the client-side terminal 12, the car residual rate predictive-value is outputted to the client-side terminal 12 through the communication network 11. The car residual rate predictive-value thus obtained may be stored in the second data memory device 10d.

As explained earlier, according to the embodiment of the invention, categorization data incapable of quantifying can be dealt with collectively, and the prediction limits found in a conventional method can be fundamentally overcome by deriving a theoretical equation statistical-analytically as an optimum solution by use of the qualification theory I of a superordinate concept of a common multiple regression analysis. Thus, the present invention needs not subdivide the basal records to make sufficient functions of the law of large numbers, and further, requires no artificial ingenuity such as fiction of an attribute value of the basal record with a representative attribute value, consequently to prevent prediction accuracy from deteriorating. Beside, the invention can deal with categorization data, so that irregular alteration can be coped with by converting categorization data to quantitative data by means of adequate classification when change in quantitative data does not necessarily cause monotonic linear change in the car residual value, consequently to further enhance the prediction accuracy.

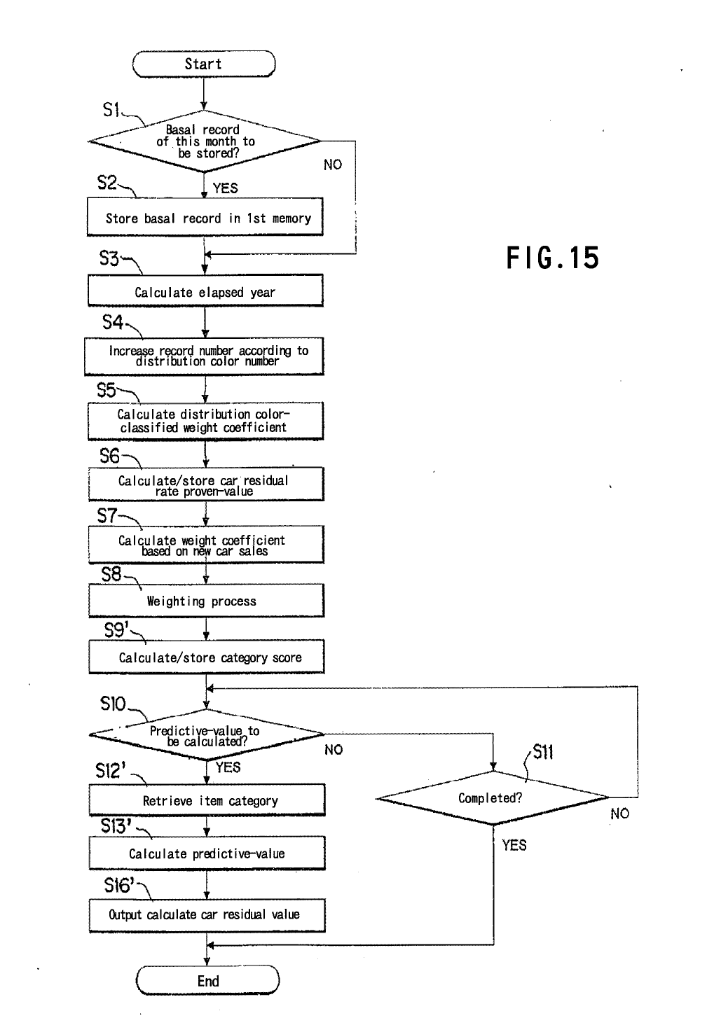

FIG. 15 is a flowchart schematically illustrating a part of the program of the car residual value predicting computer in another embodiment of FIG. 1, relating to a car residual value predicting system suitable for use in a car insurance underwriter.

This embodiment has analogous structures, operations and functions to those illustrated in FIG. 1 through FIG. 14 except for absence of Step S14 and S15 in the program of the car residual value predicting computer in FIG. 3 and minor modification in processes at Steps S9, S12, S13 and S16. Therefore, only the processes of the steps different in practical formation from the foregoing embodiment will be described hereinafter.

An insurance company releases an auto insurance package for comprehensively covering car residual value on a year-round basis, in which a theoretical equation without recourse to a month-classified score is used and the month-classified compensation as noted above is not performed. That is, the item category score is calculated by performing a regression analysis based on the qualification theory I using data read out from the first data memory device 10c such as the car name and the year to which the used article value is applied as an explanatory variable and the car residual rate proven-value as an objective variable by the category score calculating means 10b₇ at Step S9′ in FIG. 15, and then, stored in the second data memory device 10d. The item category with respect to the car name and applied year of the relevant car to be predicted is received at Step S12′ in FIG. 15. As one example, there is received the item category indicating that the car name is “AAA” and the applied year is the year of 2007. At the next Step S13′, a score corresponding to the received item category is read out from the second data memory device 10d by the car residual rate predictive-value calculating means 10b₈, and a year-classified score corresponding to the year at some future point to be predicted is adopted as the year-classified score, e.g. year-classified score of the nearest year, to calculate the car residual rate predictive-value.

To be specific, an arithmetic processing according to the following equation (9) is performed.

(Car residual rate predictive-value)=(Car name-classified score)+(Year-classified score)+(Constant value) (9)

There is adopted here the year-classified score of a predictive-value for the year at some future point to be predicted, namely, the year-classified score of the nearest year in view of an upward trend in this embodiment of the invention. The year-classified score obtained with the trend or an average value may be used. At the next Step S16′, the car residual rate predictive-value calculated at Step S13′ is multiplied by the new car value of the relevant car without compensation based on the number of elapsed months, thereby to obtain the car residual value to be given to the predicting operator.

Namely, the following equation (10) is performed.

(Car residual value)=(New car value)×(Car residual rate predictive-value) (10)

As is described above, according to the embodiment of the invention, categorization data incapable of quantifying can be dealt with collectively, and the prediction limits found in a conventional method can be fundamentally overcome by deriving a theoretical equation statistical-analytically as an optimum solution by use of the qualification theory I of a superordinate concept of a common multiple regression analysis. That is to say, the present invention needs not subdivide the basal records to make sufficient functions of the law of large numbers like prediction according to the theoretical equation such as a multiple regression analysis using numerical type data only, and further, requires no artificial ingenuity such as fiction of an attribute value of the basal record with a representative attribute value, consequently to prevent prediction accuracy from deteriorating. Beside, the invention can deal with categorization data, so that irregular alteration can be coped with by converting categorization data to quantitative data by means of adequate classification when change in quantitative data does not necessarily cause monotonic linear change in the car residual value, consequently to further enhance the prediction accuracy.

The aforementioned embodiment is described above for illustrative purposes, but should not be understood as being limited thereto, and the invention is capable of numerous rearrangements, modifications and substitution of parts and elements. Accordingly, the scope of the invention should be stipulated by claims set forth herein and the scope of equivalence thereto.

### INDUSTRIAL APPLICABILITY

The present invention enables prediction of an article residual value or a car residual value with a high degree of accuracy, so that a lease fee system in leasing business of an article or car can be so restructured fabulously that the higher the popularity stakes in the used article or used car market, the lower a lease fee is by setting the lease fee based on a price reduction rate after preliminary deduction of the article residual value or car residual value at the time of leasing-up from the new article value or new car value. Thus, the present invention is useful for business category dealing with lease articles or lease cars and makes it possible to sell articles or cars at a lower price as it grows in popularity by setting the price of the article or car to be sold after preliminary deduction of future predictive residual value form the new article value or new car value with consideration for future trade-in price. Further, this invention can be effectively applied to the housing market or the market of personal computers and electric appliances.

What is claimed is:

1. An article residual value predicting device comprising an article residual value predicting computer, a first data memory device connected to said article residual value predicting computer to store, as basal record data, respective items such as article names, used article values for each article type, new article values for each article type, and year and month data to which the used article value is applied, a second data memory device connected to said article residual value predicting computer to store item category scores,
said article residual value predicting computer comprising article residual rate proven-value calculating means for reading out said used article value and new article value for each article type stored in said first data memory device, calculating article residual rate proven-value from the ratio of said used article value to said new article value, and storing a calculated result thus obtained as an article residual rate proven-value in said first data memory device, category score calculating means for reading out the article name, article residual rate proven-value, and year and month data to which the used article value is applied, which are stored in said first data memory device, and calculating an item category score by performing a regression analysis based on the qualification theory I using the readout article residual rate proven-value as an objective variable and the readout article name, the year to which the used article value is applied as an explanatory variable and the month to which the used article value is applied as an explanatory variable, and storing a calculated score thus obtained in said second data memory device, article residual rate predictive-value calculating means for reading out the score stored in said second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(month-classified score)+(constant value)”, and article residual rate calculating means for multiplying the article residual rate predictive-value by a new article value to calculate an article residual value,
said first data memory device serving to store maker-classified new article sales quantity or article name-classified new article sales quantity before elapsed years,
said article residual value predicting computer comprising a first weight coefficient calculating means for reading out the maker-classified new article sales quantity or article name-classified new article sales quantity before elapsed years stored in said first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in said first data memory device, and weighting means for reading out the weight coefficient based on the calculated new article sales quantity from said first data memory device and duplicating the number of relevant records stored in said first data memory device corresponding to the weight coefficient based on the readout new article sales quantity and storing the record numbers increased by duplicating, and
said category score calculating means serving to perform said regression analysis using concurrently all the relevant records weighted by said weighting means collectively.

2. The article residual value predicting device set forth in claim 1, wherein said article residual value predicting computer comprises determination means for determining whether compensation is required for correcting a distinction in number of elapsed months attributable to an applied month, and elapsed-month number compensating means for compensating article residual rate predictive-value calculated by said article residual rate predictive-value calculating means in accordance with the average number of elapsed months for each applied month when determining that compensation is required by said determination means.

3. The article residual value predicting device set forth in claim 2, wherein said elapsed-month number compensating means is formed to perform linear interpolation of the article residual rate predictive-value in increasing or decreasing the number of elapsed years by one year in conjunction with the article residual rate predictive-value in said number of elapsed years.

4. The article residual value predicting device set forth in claim 1, wherein said category score calculating means comprises an elapsed year-classified record retrieving means for calculating the number of elapsed years from a difference between the year to which the used article value is applied as an explanatory variable and the model year of the article and reading out all the records corresponding to the elapsed years thus calculated from said first data memory device.

5. An article residual value predicting device comprising an article residual value predicting computer, a first data memory device connected to said article residual value predicting computer to store, as basal record data, respective items such as article names, used article values for each article type, new article values for each article type, and year and month data to which the used article value is applied, a second data memory device connected to said article residual value predicting computer to store item category scores,
said article residual value predicting computer comprising article residual rate proven-value calculating means for reading out the used article value and new article value for each article type stored in said first data memory device, calculating article residual rate proven-value from the ratio of the used article value to the new article value, and storing a calculated result thus obtained as an article residual rate proven-value in said first data memory device, category score calculating means for reading out the article name, article residual rate proven-value, year data to which the used article value is applied and month data to which the used article value is applied, which are stored in said first data memory device, and calculating an item category score by performing a regression analysis based on the qualification theory I using the readout article residual rate proven-value as an objective variable and the readout article name, the year to which the used article value is applied as an explanatory variable and the month to which the used article value is applied as an explanatory variable, and storing a calculated score thus obtained in said second data memory device, article residual rate predictive-value calculating means for reading out the score stored in said second data memory device with respect to a specified item category and adopting a year-classified score relative to the year at some figure point to be predicted as the year-classified score to calculate an article residual rate predictive-value from an equation “(article residual rate predictive-value)=(item-classified score)+(year-classified score)+(month-classified score)+(constant value)”, and article residual rate calculating means for multiplying the article residual rate predictive-value by a new article value to calculate an article residual value,
said first data memory device serving to store maker-classified new article sales quantity or article name-classified new article sales quantity before elapsed years, and respectively store one or more distribution colors differing from one another and used article distribution color values involved in the distribution colors,
said article residual value predicting computer comprising a first weight coefficient calculating means for reading out the maker-classified new article sales quantity or article name-classified new article sales quantity before elapsed years stored in said first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in said first data memory device, second weight coefficient calculating means for calculating the distribution color-classified weight coefficient for each distribution color according to the different distribution colors stored in said first data memory device and storing the calculated weight coefficient for each distribution color in said first data memory device, weighting means for reading out the weight coefficient based on the calculated new article sales quantity from said first data memory device and the distribution color-classified weight coefficient, multiplying the weight coefficient based on the calculated new article sales quantity by said first data memory device and the distribution color-classified weight coefficient to calculate a total weight coefficient and duplicating the number of relevant records stored in said first data memory device corresponding to the calculated total weight coefficient and storing the record numbers increased by duplicating, and
said category score calculating means serves to perform said regression analysis using concurrently all the relevant records weighted by said weighting means collectively.

6. The article residual value predicting device set forth in claim 5, wherein said article residual value predicting computer comprises determination means for determining whether compensation is required for correcting a distinction in number of elapsed months attributable to an applied month, and elapsed-month number compensating means for compensating article residual rate predictive-value calculated by said article residual rate predictive-value calculating means in accordance with the average number of elapsed months for each applied month when determining that compensation is required by said determination means.

7. The article residual value predicting device set forth in claim 6, wherein said elapsed-month number compensating means is formed to perform linear interpolation of the article residual rate predictive-value in increasing or decreasing the number of elapsed years by one year in conjunction with the article residual rate predictive-value in the aforesaid number of elapsed years.

8. The article residual value predicting device set forth in claim 5, wherein said category score calculating means comprises an elapsed year-classified record retrieving means for calculating the number of elapsed years from a difference between the year to which the used article value is applied as an explanatory variable and the model year of the article and reading out all the records corresponding to the elapsed years thus calculated from said first data memory device.

9. The article residual value predicting device set forth in claim 5, wherein said first data memory device serves to store, as one distribution color and a used article value of the used article of the distribution color, the used article value associated with the most distribution color, to store, as the distribution colors differing from one another and the used article distribution color value involved in the distribution colors, the used article value associated with the most distribution color and the used article value associated with a second-most distribution color, or to store the used article value associated with the most distribution color, the used article value associated with the second-most distribution color, and the used article value associated with third-most distribution color.

10. An article residual value predicting system comprising a client-side terminal, and a server-side article residual value predicting device connected to said client-side terminal through communication network,
said article residual value predicting device comprises an article residual value predicting computer, a first data memory device connected to said article residual value predicting computer to store, as basal record data, respective items such as article names, used article values for each article type, new article values for each article type, and year and month data to which the used article value is applied, a second data memory device connected to the article residual value predicting computer to store item category scores,
said article residual value predicting computer comprising article residual rate proven-value calculating means for reading out the used article value and new article value for each article type stored in said first data memory device, calculating article residual rate proven-value from the ratio of the used article value to the new article value, and storing a calculated result thus obtained as an article residual rate proven-value in said first data memory device, category score calculating means for reading out the article name, article residual rate proven-value, year data to which the used article value is applied and month data to which the used article value is applied, which are stored in said first data memory device, and calculating an item category score by performing a regression analysis based on the qualification theory I using the readout article residual rate proven-value as an objective variable and the readout article name, the year to which the used article value is applied as an explanatory variable and the month to which the used article value is applied as an explanatory variable, and storing a calculated score thus obtained in said second data memory device, article residual rate predictive-value calculating means for reading out the score stored in said second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(month-classified score)+(constant value)”, and article residual rate calculating means for multiplying the article residual rate predictive-value by a new article value to calculate an article residual value.
said first data memory device serving to store maker-classified new article sales quantity or article name-classified new article sales quantity before elapsed years,
said article residual value predicting computer comprising a first weight coefficient calculating means for reading out the maker-classified new article sales quantity or article name-classified new article sales quantity before elapsed years stored in said first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in said first data memory device, and weighting means for reading out the weight coefficient based on the calculated new article sales quantity from said first data memory device and duplicating the number of relevant records stored in said first data memory device corresponding to the weight coefficient based on the readout new article sales quantity and storing the record numbers increased by duplicating, and
said category score calculating means serving to perform said regression analysis using concurrently all the relevant records weighted by said weighting means collectively.

11. The article residual value predicting system set forth in claim 10, wherein said article residual value predicting computer in the article residual value predicting device comprises determination means for determining whether compensation is required for correcting a distinction in number of elapsed months attributable to an applied month, and elapsed-month number compensating means for compensating article residual rate predictive-value calculated by said article residual rate predictive-value calculating means in accordance with the average number of elapsed months for each applied month when determining that compensation is required by said determination means.

12. The article residual value predicting system set forth in claim 11, wherein said elapsed-month number compensating means is formed to perform linear interpolation of the article residual rate predictive-value in increasing or decreasing the number of elapsed years by one year in conjunction with the article residual rate predictive-value in the aforesaid number of elapsed years.

13. The article residual value predicting system set forth in claim 10, wherein said category score calculating means in said article residual value predicting device comprises an elapsed year-classified record retrieving means for calculating the number of elapsed years from a difference between the year to which the used article value is applied as an explanatory variable and the model year of the article and reading out all the records corresponding to the elapsed years thus calculated from said first data memory device.

14. An article residual value predicting system comprising a client-side terminal, and a server-side article residual value predicting device connected to said client-side terminal through communication network,
said article residual value predicting device comprises an article residual value predicting computer, a first data memory device connected to said article residual value predicting computer to store, as basal record data, respective items such as article names, used article values for each article type, new article values for each article type, and year and month data to which the used article value is applied, a second data memory device connected to the article residual value predicting computer to store item category scores,
said article residual value predicting computer comprising article residual rate proven-value calculating means for reading out the used article value and new article value for each article type stored in said first data memory device, calculating article residual rate proven-value from the ratio of the used article value to the new article value, and storing a calculated result thus obtained as an article residual rate proven-value in said first data memory device, category score calculating means for reading out the article name, article residual rate proven-value, year data to which the used article value is applied and month data to which the used article value is applied, which are stored in said first data memory device, and calculating an item category score by performing a regression analysis based on the qualification theory I using the readout article residual rate proven-value as an objective variable and the readout article name, the year to which the used article value is applied as an explanatory variable and the month to which the used article value is applied as an explanatory variable, and storing a calculated score thus obtained in said second data memory device, article residual rate predictive-value calculating means for reading out the score stored in said second data memory device with respect to a specified item category and adopting a year-classified score relative to the year at some future point to be predicted as the year-classified score to calculate an article residual rate predictive-value from an equation “(article residual rate predictive-value)=(item-classified score)+(year-classified score)+(month-classified score)+(constant value)”, and article residual rate calculating means for multiplying the article residual rate predictive-value by a new article value to calculate an article residual value.
said first data memory device serving to store maker-classified new article sales quantity or article name-classified new article sales quantity before elapsed years, and respectively store one or more distribution colors differing from one another and used article distribution color values involved in the distribution colors,
said article residual value predicting computer comprising a first weight coefficient calculating means for reading out the maker-classified new article sales quantity or article name-classified new article sales quantity before elapsed years stored in said first data memory device, calculating a weight coefficient from an equation “(maker-classified new article sales quantity before elapsed years)/(maker-classified record number)” or “(article name-classified new article sales quantity before elapsed years)/(article name-classified record number)”, and storing the weight coefficient based on the calculated new article sales quantity in said first data memory device, second weight coefficient calculating means for calculating the distribution color-classified weight coefficient for each distribution color according to the different distribution colors stored in said first data memory device and storing the calculated weight coefficient for each distribution color in said first data memory device, weighting means for reading out the weight coefficient based on the calculated new article sales quantity from said first data memory device and the distribution color-classified weight coefficient, multiplying the weight coefficient based on the calculated new article sales quantity by said first data memory device and the distribution color-classified weight coefficient to calculate a total weight coefficient and duplicating the number of relevant records stored in said first data memory device corresponding to the calculated total weight coefficient and storing the record numbers increased by duplicating, and
said category score calculating means serves to perform said regression analysis using concurrently all the relevant records weighted by said weighting means collectively.

15. The article residual value predicting system set forth in claim 14, wherein said article residual value predicting computer in said article residual value predicting device comprises determination means for determining whether compensation is required for correcting a distinction in number of elapsed months attributable to an applied month, and elapsed-month number compensating means for compensating article residual rate predictive-value calculated by said article residual rate predictive-value calculating means in accordance with the average number of elapsed months for each applied month when determining that compensation is required by said determination means.

16. The article residual value predicting system set forth in claim 15, wherein said elapsed-month number compensating means is formed to perform linear interpolation of the article residual rate predictive-value in increasing or decreasing the number of elapsed years by one year in conjunction with the article residual rate predictive-value in the aforesaid number of elapsed years.

17. The article residual value predicting system set forth in claim 14, wherein said category score calculating means in said article residual value predicting device comprises an elapsed year-classified record retrieving means for calculating the number of elapsed years from a difference between the year to which the used article value is applied as an explanatory variable and the model year of the article and reading out all the records corresponding to the elapsed years thus calculated from said first data memory device.

18. The article residual value predicting system set forth in claim 14, wherein said first data memory device in said article residual value predicting device serves to store, as one distribution color and a used article value of the used article of the distribution color, the used article value associated with the most distribution color, to store, as the distribution colors differing from one another and the used article distribution color value involved in the distribution colors, the used article value associated with the most distribution color and the used article value associated with a second-most distribution color, or to store the used article value associated with the most distribution color, the used article value associated with the second-most distribution color, and the used article value associated with third-most distribution color.

19. A car residual value predicting device comprises a car residual value predicting computer, a first data memory device connected to the car residual value predicting computer to store, as basal record data, respective items such as car names, used car values for each car type, new car values for each car type, and year and month data to which the used car value is applied, a second data memory device connected to the car residual value predicting computer to store item category scores,
said car residual value predicting computer comprising car residual rate proven-value calculating means for reading out the used car value and new car value for each car type stored in said first data memory device, calculating car residual rate proven-value from the ratio of the used car value to the new car value, and storing a calculated result thus obtained as a car residual rate proven-value in said first data memory device, category score calculating means for reading out the car name, car residual rate proven-value, year data to which the used car value is applied and month data to which the used car value is applied, which are stored in said first data memory device, and calculating an item category score by performing a regression analysis based on the qualification theory I using the readout car residual rate proven-value as an objective variable and the readout car name, the year to which the used car value is applied as an explanatory variable and the month to which the used car value is applied as an explanatory variable, and storing a calculated score thus obtained in said second data memory device, car residual rate predictive-value calculating means for reading out the score stored in said second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(month-classified score)+(constant value)”, and car residual rate calculating means for multiplying the car residual rate predictive-value by a new car value to calculate a car residual value,
said first data memory device serving to store maker-classified new car sales quantity or car name-classified new car sales quantity before elapsed years,
said car residual value predicting computer comprising a first weight coefficient calculating means for reading out the maker-classified new car sales quantity or car name-classified new car sales quantity before elapsed years stored in said first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in said first data memory device, and weighting means for reading out the weight coefficient based on the calculated new car sales quantity from said first data memory device and duplicating the number of relevant records stored in said first data memory device corresponding to the weight coefficient based on the readout new car sales quantity and storing the record numbers increased by duplicating, and
said category score calculating means serving to perform said regression analysis using concurrently all the relevant records weighted by the weighting means collectively.

20. The car residual value predicting device set forth in claim 19, wherein said car residual value predicting computer comprises determination means for determining whether compensation is required for correcting a distinction in number of elapsed months attributable to an applied month, and elapsed-month number compensating means for compensating car residual rate predictive-value calculated by said car residual rate predictive-value calculating means in accordance with the average number of elapsed months for each applied month when determining that compensation is required by said determination means.

21. The car residual value predicting device set forth in claim 20, wherein said elapsed-month number compensating means so as to perform linear interpolation of the car residual rate predictive-value in increasing or decreasing the number of elapsed years by one year in conjunction with the car residual rate predictive-value in the aforesaid number of elapsed years.

22. The car residual value predicting device set forth in claim 19, wherein said car type is stipulated according to the model year, approval type, car grade, shift indicating transmission type, car type describing the number of doors and a body shape, engine displacement and distribution color for each car name.

23. The car residual value predicting device set forth in claim 19, wherein said category score calculating means is provided with an elapsed year-classified record retrieving means for calculating the number of elapsed years from a difference between the year to which the used car value is applied as an explanatory variable and the model year of the car and reading out all the records corresponding to the elapsed years thus calculated from said first data memory device.

24. A car residual value predicting device comprising a car residual value predicting computer, a first data memory device connected to the car residual value predicting computer to store, as basal record data, car names, used car values for each car type, new car values for each car type, and year and month data to which the used car value is applied, a second data memory device connected to the car residual value predicting computer to store item category scores,
said car residual value predicting computer comprising car residual rate proven-value calculating means for reading out the used car value and new car value for each car type stored in said first data memory device, calculating car residual rate proven-value from the ratio of the used car value to the new car value, and storing a calculated result thus obtained as a car residual rate proven-value in said first data memory device, category score calculating means for reading out the car name, car residual rate proven-value, year data to which the used car value is applied and month data to which the used car value is applied, which are stored in said first data memory device, and calculating an item category score by performing a regression analysis based on the qualification theory I using the readout car residual rate proven-value as an objective variable and the readout car name, the year to which the used car value is applied as an explanatory variable and the month to which the used car value is applied as an explanatory variable, and storing a calculated score thus obtained in said second data memory device, car residual rate predictive-value calculating means for reading out the score stored in said second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(month-classified score)+(constant value)”, and car residual rate calculating means for multiplying the car residual rate predictive-value by a new car value to calculate a car residual value,
said first data memory device serving to store maker-classified new car sales quantity or car name-classified new car sales quantity before elapsed years, and respectively store one or more distribution colors differing from one another and used car distribution color values involved in the distribution colors,
said car residual value predicting computer comprising a first weight coefficient calculating means for reading out the maker-classified new car sales quantity or car name-classified new car sales quantity before elapsed years stored in said first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in said first data memory device, second weight coefficient calculating means for calculating the distribution color-classified weight coefficient for each distribution color according to the different distribution colors stored in said first data memory device and storing the calculated weight coefficient for each distribution color in said first data memory device, weighting means for reading out the weight coefficient based on the calculated new car sales quantity from said first data memory device and the distribution color-classified weight coefficient, multiplying the weight coefficient based on the calculated new car sales quantity by said first data memory device and the distribution color-classified weight coefficient to calculate a total weight coefficient and duplicating the number of relevant records stored in said first data memory device corresponding to the calculated total weight coefficient and storing the record numbers increased by duplicating, and
said category score calculating means serving to perform said regression analysis using concurrently all the relevant records weighted by said weighting means collectively.

25. The car residual value predicting device set forth in claim 24, wherein said car residual value predicting computer comprises determination means for determining whether compensation is required for correcting a distinction in number of elapsed months attributable to an applied month, and elapsed-month number compensating means for compensating car residual rate predictive-value calculated by said car residual rate predictive-value calculating means in accordance with the average number of elapsed months for each applied month when determining that compensation is required by said determination means.

26. The car residual value predicting device set forth in claim 25, wherein said elapsed-month number compensating means so as to perform linear interpolation of the car residual rate predictive-value in increasing or decreasing the number of elapsed years by one year in conjunction with the car residual rate predictive-value in the aforesaid number of elapsed years.

27. The car residual value predicting device set forth in claim 24, wherein said car type is stipulated according to the model year, approval type, car grade, shift indicating transmission type, car type describing the number of doors and a body shape, engine displacement and distribution color for each car name.

28. The car residual value predicting device set forth in claim 24, wherein said category score calculating means is provided with an elapsed year-classified record retrieving means for calculating the number of elapsed years from a difference between the year to which the used car value is applied as an explanatory variable and the model year of the car and reading out all the records corresponding to the elapsed years thus calculated from said first data memory device.

29. The car residual value predicting device set forth in claim 24, wherein said first data memory device preferably serves to store, as one distribution color and a used car value of the used car of the distribution color, the used car value associated with the most distribution color, to store, as the distribution colors differing from one another and the used car distribution color value involved in the distribution colors, the used car value associated with the most distribution color and the used car value associated with a second-most distribution color, or to store the used car value associated with the most distribution color, the used car value associated with the second-most distribution color, and the used car value associated with third-most distribution color.

30. A car residual value predicting system comprising a client-side terminal, and a server-side car residual value predicting device connected to said client-side terminal through communication network,
said car residual value predicting device comprising a car residual value predicting computer, a first data memory device connected to said car residual value predicting computer to store, as basal record data, each item of car names, used car values for each car type, new car values for each car type, and year and month data to which the used car value is applied, a second data memory device connected to said car residual value predicting computer to store item category scores,
said car residual value predicting computer comprising car residual rate proven-value calculating means for reading out the used car value and new car value for each car type stored in said first data memory device, calculating car residual rate proven-value from the ratio of the used car value to the new car value, and storing a calculated result thus obtained as a car residual rate proven-value in said first data memory device, category score calculating means for reading out the car name, car residual rate proven-value, year data to which the used car value is applied and month data to which the used car value is applied, which are stored in said first data memory device, and calculating an item category score by performing a regression analysis based on the qualification theory I using the readout car residual rate proven-value as an objective variable and the readout car name, the year to which the used car value is applied as an explanatory variable and the month to which the used car value is applied as an explanatory variable, and storing a calculated score thus obtained in said second data memory device, car residual rate predictive-value calculating means for reading out the score stored in said second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(month-classified score)+(constant value)”, and car residual rate calculating means for multiplying the car residual rate predictive-value by a new car value to calculate a car residual value,
said first data memory device serving to store maker-classified new car sales quantity or car name-classified new car sales quantity before elapsed years,
said car residual value predicting computer comprising a first weight coefficient calculating means for reading out the maker-classified new car sales quantity or car name-classified new car sales quantity before elapsed years stored in said first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in said first data memory device, and weighting means for reading out the weight coefficient based on the calculated new car sales quantity from said first data memory device and duplicating the number of relevant records stored in said first data memory device corresponding to the weight coefficient based on the readout new car sales quantity and storing the record numbers increased by duplicating, and
said category score calculating means serving to perform said regression analysis using concurrently all the relevant records weighted by the weighting means collectively.

31. The car residual value predicting system set forth in claim 30, wherein said car residual value predicting computer in said car residual value predicting device comprises determination means for determining whether compensation is required for correcting a distinction in number of elapsed months attributable to an applied month, and elapsed-month number compensating means for compensating car residual rate predictive-value calculated by said car residual rate predictive-value calculating means in accordance with the average number of elapsed months for each applied month when determining that compensation is required by said determination means.

32. The car residual value predicting system set forth in claim 31, wherein said elapsed-month number compensating means so as to perform linear interpolation of the car residual rate predictive-value in increasing or decreasing the number of elapsed years by one year in conjunction with the car residual rate predictive-value in the aforesaid number of elapsed years.

33. The car residual value predicting system set forth in claim 30, wherein said car type is stipulated according to the model year, approval type, car grade, shift indicating transmission type, car type describing the number of doors and a body shape, engine displacement and distribution color for each car name.

34. The car residual value predicting system set forth in claim 30, wherein said category score calculating means in said car residual value predicting device is provided with an elapsed year-classified record retrieving means for calculating the number of elapsed years from a difference between the year to which the used car value is applied as an explanatory variable and the model year of the car and reading out all the records corresponding to the elapsed years thus calculated from said first data memory device.

35. A car residual value predicting system comprising a client-side terminal, and a server-side car residual value predicting device connected to said client-side terminal through communication network,
said car residual value predicting device comprising a car residual value predicting computer, a first data memory device connected to the car residual value predicting computer to store, as basal record data, car names, used car values for each car type, new car values for each car type, and year and month data to which the used car value is applied, a second data memory device connected to the car residual value predicting computer to store item category scores,
said car residual value predicting computer comprising car residual rate proven-value calculating means for reading out the used car value and new car value for each car type stored in said first data memory device, calculating car residual rate proven-value from the ratio of the used car value to the new car value, and storing a calculated result thus obtained as a car residual rate proven-value in said first data memory device, category score calculating means for reading out the car name, car residual rate proven-value, year data to which the used car value is applied and month data to which the used car value is applied, which are stored in said first data memory device, and calculating an item category score by performing a regression analysis based on the qualification theory I using the readout car residual rate proven-value as an objective variable and the readout car name, the year to which the used car value is applied as an explanatory variable and the month to which the used car value is applied as an explanatory variable, and storing a calculated score thus obtained in said second data memory device, car residual rate predictive-value calculating means for reading out the score stored in said second data memory device with respect to a specified item category and adopting a year-classified score relative to the year at some future point to be predicted as the year-classified score to calculate a car residual rate predictive-value from an equation “(car residual rate predictive-value)=(item-classified score)+(year-classified score)+(month-classified score)+(constant value)”, and car residual rate calculating means for multiplying the car residual rate predictive-value by a new car value to calculate a car residual value,
said first data memory device serving to store maker-classified new car sales quantity or car name-classified new car sales quantity before elapsed years, and respectively store one or more distribution colors differing from one another and used car distribution color values involved in the distribution colors,
said car residual value predicting computer comprising a first weight coefficient calculating means for reading out the maker-classified new car sales quantity or car name-classified new car sales quantity before elapsed years stored in said first data memory device, calculating a weight coefficient from an equation “(maker-classified new car sales quantity before elapsed years)/(maker-classified record number)” or “(car name-classified new car sales quantity before elapsed years)/(car name-classified record number)”, and storing the weight coefficient based on the calculated new car sales quantity in said first data memory device, second weight coefficient calculating means for calculating the distribution color-classified weight coefficient for each distribution color according to the different distribution colors stored in said first data memory device and storing the calculated weight coefficient for each distribution color in said first data memory device, weighting means for reading out the weight coefficient based on the calculated new car sales quantity from said first data memory device and the distribution color-classified weight coefficient, multiplying the weight coefficient based on the calculated new car sales quantity by said first data memory device and the distribution color-classified weight coefficient to calculate a total weight coefficient and duplicating the number of relevant records stored in said first data memory device corresponding to the calculated total weight coefficient and storing the record numbers increased by duplicating, and
said category score calculating means serving to perform said regression analysis using concurrently all the relevant records weighted by said weighting means collectively.

36. The car residual value predicting system set forth in claim 35, wherein said car residual value predicting computer in said car residual value predicting device comprises determination means for determining whether compensation is required for correcting a distinction in number of elapsed months attributable to an applied month, and elapsed-month number compensating means for compensating car residual rate predictive-value calculated by said car residual rate predictive-value calculating means in accordance with the average number of elapsed months for each applied month when determining that compensation is required by said determination means.

37. The car residual value predicting system set forth in claim 36, wherein said elapsed-month number compensating means so as to perform linear interpolation of the car residual rate predictive-value in increasing or decreasing the number of elapsed years by one year in conjunction with the car residual rate predictive-value in the aforesaid number of elapsed years.

38. The car residual value predicting system set forth in claim 35, wherein said car type is stipulated according to the model year, approval type, car grade, shift indicating transmission type, car type describing the number of doors and a body shape, engine displacement and distribution color for each car name.

39. The car residual value predicting system set forth in claim 35, wherein said category score calculating means in said car residual value predicting device is provided with an elapsed year-classified record retrieving means for calculating the number of elapsed years from a difference between the year to which the used car value is applied as an explanatory variable and the model year of the car and reading out all the records corresponding to the elapsed years thus calculated from said first data memory device.

40. The car residual value predicting system set forth in claim 35, wherein said first data memory device in said car residual value predicting device serves to store, as one distribution color and a used car value of the used car of the distribution color, the used car value associated with the most distribution color, to store, as the distribution colors differing from one another and the used car distribution color value involved in the distribution colors, the used car value associated with the most distribution color and the used car value associated with a second-most distribution color, or to store the used car value associated with the most distribution color, the used car value associated with the second-most distribution color, and the used car value associated with third-most distribution color.
